(19) United States
(12) Patent Application Publication
(10) Pub. No.: US 2026/0003701 A1
(43) Pub. Date: Jan. 1, 2026

(54) IN-CONTEXT AUTOMATION RULE BUILDER FOR COLLABORATION PLATFORMS

(71) Applicant: Atlassian Pty Ltd., Sydney (AU)

(72) Inventors: Alexander Williams, Richmond, VA (US); Phuc Le, Milpitas, CA (US); Avinoam Zelenko, Parkland, FL (US); Anand Srikrishnan Kashyap, Saratoga, CA (US)

(21) Appl. No.: 18/755,516

(22) Filed: Jun. 26, 2024

(51) Int. Cl. G06F 9/54; G06F 3/0482; G06F 3/0484

(52) U.S. Cl. CPC G06F 9/543; G06F 3/0484; G06F 3/0482

(57) ABSTRACT

Embodiments described herein relate to systems and methods for suggesting automation rules in collaboration platforms. A graphical user interface of the content collaboration platform may be displayed. In response to a first user input to the graphical user interface, an automation rule template may be selected. A rule suggestion interface having a set of graphical elements may be displayed, each graphical element corresponding to a respective automation component of the automation rule template. In response to a second user input, a value may be assigned to an instance of an automation component associated with a graphical element of the set of graphical elements. In response to a third user input a new automation rule may be created based on the automation components of the automation rule template.

### TECHNICAL FIELD

Embodiments described herein relate to multitenant services of collaborative work environments and, in particular, to systems and methods for automation rule creation for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particular ways, to copy data or status information between multiple platforms at specific times, or to perform other rigidly defined, policy-driven tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A depicts a simplified diagram of a system that includes a centralized automation rule service for the creation of automation rules.

FIG. 1B depicts a simplified diagram of a centralized automation rule service for the creation in communication with a client device.

FIG. 2 depicts an example frontend interface of a collaboration platform, in accordance with aspects described herein.

FIG. 3A depicts an example frontend interface including an automation rule suggestion prompt, in accordance with aspects described herein.

FIGS. 3B-3D depict an example frontend interface including an automation rule suggestion interface, in accordance with aspects described herein.

FIGS. 4A-4E depict another example frontend interface including an automation rule suggestion interface, in accordance with aspects described herein.

FIG. 5A depicts an example frontend interface including an automation rule suggestion prompt, in accordance with aspects described herein.

FIG. 5B depicts an example frontend interface including an automation rule suggestion interface, in accordance with aspects described herein.

FIGS. 6A-6B depict an example frontend interface that supports automation rule creation, modification, and/or customization, in accordance with aspects described herein.

FIG. 7 depicts an example frontend interface that supports automation rule creation for collaboration platforms, in accordance with aspects described herein.

FIG. 8 depicts an example frontend interface that supports automation rule creation for collaboration platforms, in accordance with aspects described herein.

FIG. 9 depicts an example frontend interface that supports automation rule creation for collaboration platforms, in accordance with aspects described herein.

FIG. 10 depicts an example frontend interface that supports automation rule creation for collaboration platforms, in accordance with aspects described herein.

FIG. 11 depicts an example frontend interface that supports automation rule creation for collaboration platforms, in accordance with aspects described herein.

FIG. 12 depicts an example frontend interface that supports automation rule creation for collaboration platforms, in accordance with aspects described herein.

FIG. 13 depicts an example frontend interface that supports automation rule creation for collaboration platforms, in accordance with aspects described herein.

FIG. 14 depicts an example frontend interface that supports automation rule creation for collaboration platforms, in accordance with aspects described herein.

FIGS. 15A-15D depict examples of a first portion, a second portion, a third portion, and a fourth portion of a frontend interface that supports automation rule creation for collaboration platforms, in accordance with aspects described herein.

FIG. 16 depicts an example of a portion of a frontend interface that supports automation rule creation for collaboration platforms, in accordance with aspects described herein.

FIG. 17 depicts an example method of automation rule creation, in accordance with aspects described herein.

FIG. 18 depicts a system diagram and network/communication architectures that may support a system as described herein.

FIG. 19 depicts a functional system diagram of network/communication architectures that may support a system as described herein.

FIG. 20 depicts a simplified system diagram and data processing pipeline.

FIG. 21 depicts a system providing multiplatform prompt management as a service.

FIG. 22 depicts an example process flow that supports automation rule creation for collaboration platforms, in accordance with aspects described herein.

FIG. 23 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source-code management platform or service that is configured to manage source code and other aspects of a software product, a manufacturing resource planning platform or service configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in an “if this, then that” format. Typically, for example in a collaboration platform, an automation rule results in the performance of an action upon the occurrence of a trigger, if certain conditions are met. In a collaboration platform, each automation rule is made by combining different types of automation components (also referred to as components), including triggers and actions. An automation rule typically also includes a condition. Branches may also be used in some cases. As used herein, automation rules begin with a trigger (which may also be referred to as a trigger component), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule does or performs, for example, what happens when the trigger (and condition(s), if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of content to be managed. Certain tasks may require many repetitive actions or a person responsible for managing content may not realize that an action may need to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors. However, the creation of automation rules can require multiple steps, technical acumen, knowledge of terms, connectors, and other specialized language that may not be known to a typical user of the collaboration platform.

Tools for automation rule building may be used to assist users of a system to more easily generate automation rules using little to no code. In some tools, automation rule components (e.g., elements, blocks) may be provided for a user. These components may include triggers, actions, branches, and so on that represent underlying blocks of code, and may further include fields that can be customized by the user for a specific use case. Using these components, a user can more easily (e.g., in a graphical user interface) create automation rules.

However, users may not be aware of the existence of the tools for building automation rules, or may otherwise not actively utilize the automation rule functionality of a collaborative platform. Lack of utilization of these features may result in users missing out on services that could increase their efficiency, lower their workload, and generally improve their interactions with the collaborative platform. Accordingly, described herein are techniques that improve the visibility and increase the engagement with automation rules. In particular, and as described herein, the collaboration platform may identify when a user performs an action that is a good candidates for an automation rule, and, when such action is detected, prompt the user with an option to create an automation rule that will automate future instances of that action. For example, a user may engage with a graphical user interface of a content collaboration platform to archive a content item. Since this is a type of action that may be effectively automated using the automation rules, the collaboration platform may detect that that user attempted to archive the page and may prompt the user to create an automation rule to archive pages. Notably, the collaboration platform may select and propose automation rules that are specifically relevant to a particular user action. Thus, for example, when a user archives a page, the platform may suggest an automation rule that automatically archives pages; when a user adds a label to a page, the platform may suggest an automation rule that automatically adds labels to pages. In this way, the platform provides targeted prompts that are contextually relevant to the user's actions. This also helps increase the likelihood that a user will engage with and use the automation tools, as the suggestions are specifically related to actions that the user performs, and are not merely generic.

When a user selects an option to create an automation rule (e.g., from a prompt), a rule suggestion interface may be displayed to the user. The rule suggestion interface may include a graphical representation of the automation components that ultimately define the proposed rule. For example, the rule suggestion interface for an automatic content archiving rule may display a block representing a trigger component, a block representing a condition component, and a block representing an action component. The rule suggestion interface may be generally static or non-interactive (e.g., such that the user can simply accept the rule without further modification), or it may allow some degree of rule customization or modification. For example, the rule suggestion interface may allow a user to select certain values or parameters for the automation components (e.g., allowing the user to select which user(s) should be notified when the content item is modified, select what a triggering event is, or the like). In some cases, the rule suggestion interface provides a limited set of automation rule building tools (e.g., a subset of the rule building tools of a primary or main rule building interface) to allow the customization or modification of an automation rule. In this way, the creation of an automation rule from a system-provided suggestion prompt may be easier and/or faster than creating a rule in the main rule building interface, further increasing the likelihood of user adoption of the automation rule functionality.

In some cases, collaboration platforms may interoperate with third-party services (e.g., services that are provided by an organization or service provider that is different from the collaboration platform). Third-party services may be accessed or utilized by the collaboration platform issuing API calls to the third-party service. In some cases, the rule suggestion interface may suggest automation rules that integrate with or use third-party services. In such cases, the collaboration platform may issue one or more API calls to the third-party service in order to obtain information to include in the rule suggestion interface. For example, a collaboration platform may issue an API call to a third-party service to retrieve a list of usernames or identifiers that is managed by the third-party service. As another example, a collaboration platform may issue an API call to a third-party service to retrieve a list of project titles (e.g., which may be managed by the third-party service but are assignable to content items in the collaboration platform).

As described herein, automation rules may be subject to certain operational constraints. For example, a rule that is configured to send a notification to a user-specified individual must include an identifier or address of the user-specified individual. If such information is not provided, the automation rule cannot be executed. In order to improve the efficiency and simplicity of using the automation rule suggestion system, the collaboration platform may perform a validation operation on the automation rules that are ultimately created from a rule suggestion interface. For example, in response to a user input to the rule suggestion interface to create or adopt a new automation rule, the collaboration platform (or an automation rule service associated with the collaboration platform) may perform a validation operation on the new rule, and may prompt the user if the validation operation indicates an error or other exception condition. For example, if a suggested automation rule requires a user-specified value (e.g., an identifier of a particular user, text for a label, a selection of a project), but such value has not been provided, the rule suggestion interface may alert the user to the error before attempting to create or run the new automation rule. In this way, the user can rectify any issues in a simple and efficient manner (and without having to navigate to and/or learn how to operate a more robust automation rule editor).

The automation rule suggestion interface, and the rule suggestion system more generally, provides a simple and efficient way to generate automation rules that are specifically relevant to a particular user. In particular, the automation rule suggestion interface provides predefined rule suggestions that are at least partially pre-validated to ensure that the rules will work without requiring the user to learn sophisticated rule generation techniques and tools. Further, the automation rule suggestion interface will validate any rules that are ultimately adopted by the user, and will prompt the user, prior to creating the rule instance, to correct any errors or provide any necessary additional information. Further, the automation rule suggestion interface may provide a limited subset of customization or modification options, such that a user can make certain selections without having to navigate to or otherwise interact with more sophisticated and complex rule-building tools.

In addition to providing automation rule suggestions in an automation rule suggestion interface, an automation rule builder may be provided to facilitate automation rule creation (building) for collaboration systems. In one or more embodiments, a user of a collaboration system, or a platform thereof (e.g., a user of one or more systems, programs, applications, or components of a collaboration platform), can generate an automation rule in an automation rule builder. In some cases, the automation rule builder may be accessed via an automation rule suggestion interface. For example, the automation rule suggestion interface may display an automation rule template along with an option to enable a rule based on the template, and an option to edit the rule (which is based on the template) in the automation rule builder. Thus, if the user simply wants to accept the rule as proposed, they may select the option to enable the rule directly. If they wish to make further modifications to the rule (e.g., beyond any modifications that are permitted in the automation rule suggestion interface), they may select the option to edit the rule in the rule builder. Upon receiving this selection, an automation rule according to the automation rule template may be pre-populated in the rule builder, as described herein.

The automation rule builder presents a graphical user interface (GUI) of the collaboration system (e.g., of one of the platforms of the collaboration system). Automation rule components, including triggers and actions, have corresponding graphical elements that are generated for the GUI, and displayed for a user. To assist the user in building (creating) a valid automation rule, as the user selects automation rule components (and/or modifies a pre-populated rule from an automation rule template), the collaboration system determines compatible automation rule components (e.g., compatible actions) that are based on automation rule components that have been previously selected by the user (or pre-populated from the automation rule template). The collaboration system may present compatible actions or other rule components, hide incompatible actions, or rule components, or otherwise indicate combinations or series of automation rule components that are compatible with other automation rule components. Among other benefits, determining compatibility during rule creation can assist a user in building a valid rule, as well as diagnosing errors and other issues during building of automation rules. Users building automation rules as described herein can therefore save time, lower expenses, reduce errors, increase engagement with collaboration systems, and otherwise perform administrative and management tasks more effectively and efficiently.

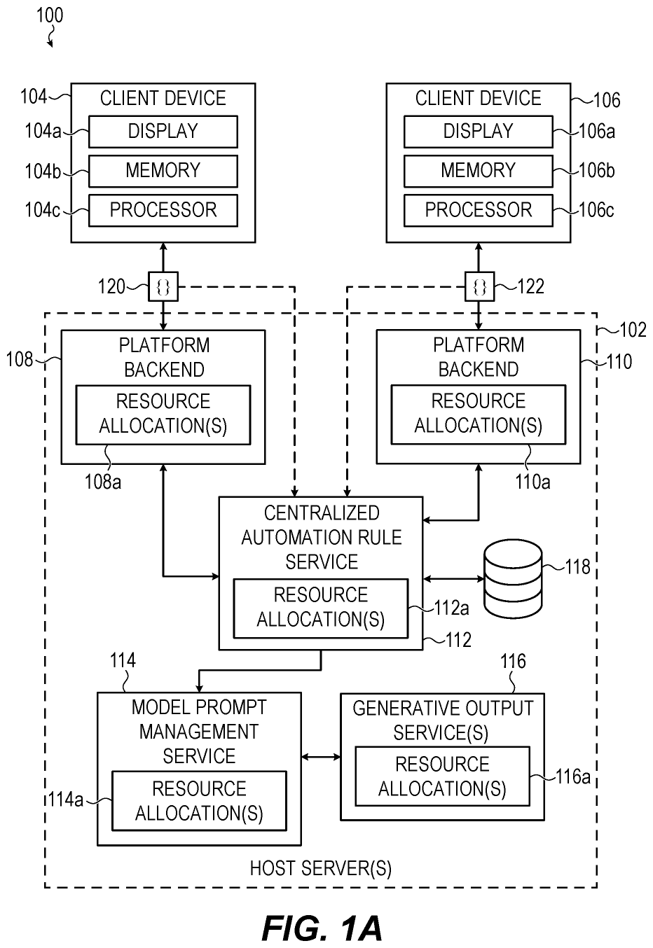

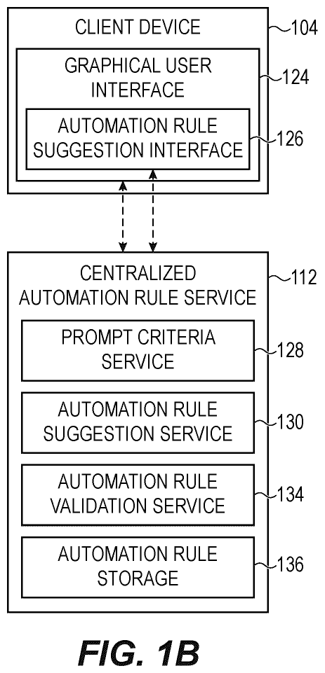

FIG. 1A depicts a simplified diagram of a system that includes a centralized automation rule service for the creation of automation rules, as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred to in many cases as a “cloud platform”). In some cases, the set of host servers 102 can be physically collocated or in other cases, each may be positioned in a geographically unique location.

The set of host servers 102 can be communicably coupled to one or more client devices. Two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include information technology system management (ITSM) systems, chat platforms, messaging platforms, and the like. These backends can be communicably coupled to a centralized automation rule service 112 that can be leveraged to provide functionality to each respective backend. For example, the centralized automation rule service 112 can be configured to receive user prompts, such as described herein, to modify, create, or otherwise perform operations to build, validate, debug, or otherwise create and manage automation rules acting on content stored by each respective software platform and triggered by events that may occurs at one or more of the software platforms. The centralized automation rule service may provide a single, unified interface to automation rules that operate across different platforms of the host servers 102, providing management and creation capabilities across different platforms of the system. The centralized automation rule service 112 may also facilitate automation rule suggestion services. For example, the automation rule service 112 may determine when a user performs an action that is associated with an automation rule template, select an automation rule template, and cause an automation rule suggestion interface to be displayed to the user. The automation rule service 112 may also perform validation operations on the automation rules adopted by a user (from an automation rule template) and create instances of an automation rule in response to user selections.

By centralizing the automation rule service as described herein, the centralized automation rule service can also serve as an integration between multiple platforms. For example, one platform may be a documentation platform and the other platform may be an issue tracking system. In these examples, a user of the documentation platform may create an automation rule that is triggered by an event that occurs on the documentation platform. An action in response to this event may be performed on one or more objects of the issue tracking system.

A portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each be communicably coupled with a centralized automation rule service 112 (also referred to as an “automation rule builder” or an “automation rule manager”).

The centralized automation rule service 112 can be configured to cause rendering of a GUI within respective frontends of each of the first platform backend 108 and the second platform backend 110. In this manner, and as a result of this construction, each of the first platform and the second platform present a consistent automation rule creation and management experience for a user.

The GUIs and other graphical elements of the centralized automation rule service 112 (e.g., a rule builder GUI, a rule suggestion interface, etc.) may include both text input functions as well as selectable graphical elements to select and edit automation rules and components. Selected graphical elements may represent triggers and/or actions across different platforms. As a result of the text input or selection of graphical elements, or the selection of an automation rule template, the centralized automation rule service 112 may present graphical elements representing the selected components that make up an automation, for example on the display 104a of a client device 104, or on the display 106a of the client device 106. As a result of this centralized architecture, multiple platforms in a multiplatform environment can leverage the features of the automation rule service. This provides a consistent experience to users while providing cross-platform features for the automation rules.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to create and manage automation rules.

As described herein, a “content editing frame” refers to a user interface element that can be leveraged by a user to draft and/or modify rich content including, but not limited to formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized automation rule service 112 configured for rich text editing, but it may be appreciated that this is merely one example.

As a result of the architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In some examples, user prompts can be provided as input to a prompt engineering/prompt preconditioning service (such as the model prompt management service 114, or simply prompt management service 114) that, in turn, provides a modified model prompt as input to a generative output service 116. As used herein, a model prompt may correspond to an input that is provided to a generative output service 116. The generative output service 116 may be hosted over the host servers 102 or, in other cases, may be a software instance instantiated over separate hardware. In some cases, the generative output service 116 may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on. In some cases, the generative output service 116 (in conjunction with the automation rule service 112) may generate, modify, supplement, or customize automation rules. For example, an automation rule suggestion interface may accept natural language user inputs requesting a change, modification, or customization to a suggested automation rule. The user input may be provided to the prompt management service 114, which in turn generates and provides a model prompt to the generative output service 116. Based on the model prompt, the generative output service 116 may produce, in conjunction with the automation rule service 112, suggested automation components to include in an automation rule, values for automation components in an automation rule, modifications to a proposed automation rule, or the like.

Embodiments described herein also describe systems and methods for sharing user interface elements rendered by a centralized automation rule service 112 and features thereof (e.g., an automation rule suggestion service 130), between different software platforms in an authenticated and secure manner. For example, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified as the resources 104a-104c of the client devices, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner or form or format. In many embodiments, as noted above, the client device 104 and in particular the first platform frontend can be configured to send an authentication token 120 along with each request transmitted to any of the first platform backend 108 or the centralized automation rule service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified as the client device resources 106a-106c, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner or form or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement an automation rule processor to receive an automation rule input provided by a user of the client device 104 to the first platform and/or to receive an automation rule input provided by a different user of the client device 106 to the second platform. Created automation rules may then be accessible to each user via the different ones of client device 104 and client device 106 for management, editing, and so on.

As noted above, the centralized automation rule service 112 ensures that common features are available to frontends of different platforms. One such class of features provided by the centralized automation rule service 112 invokes output of a generative output engine of a service such as the generative output service 116. For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system (not depicted with reference to system 100). For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

The prompt management service 114 can be configured to receive user input (provided via a graphical user interface of the client device 104 or the client device 106) from the centralized automation rule service 112. The prompt management service 114 can also be configured to receive an automation rule input from the centralized automation rule service 112 in connection with the running of an automation rule. The user input or automation rule input may include a prompt to be continued by the generative output service 116. The prompt management service 114 can be configured to modify the user input or automation rule input, to supplement the input, select a prompt from a database (e.g., the database 118) based on the input, insert the input into a template prompt, replace words within the input, perform searches of databases (such as user graphs, team graphs, and so on) of either the first platform backend 108 or the second platform backend 110, change grammar or spelling of the input, change a language of the input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input (e.g., a model prompt). More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model, or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized automation rule service 112 to return to a suitable backend application, to in turn return to or perform a task for the benefit of a client device such as the client device 104 or the client device 106. More particularly, it may be appreciated that although system 100 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized automation rule service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, some embodiments described herein, and with particular reference to system 100, relate to systems for generating, modifying, and running automation rules, as well as generating, selecting, and proposing automation rule templates (and modifying or customizing rules generated from or based on those templates).

These foregoing embodiments depicted with reference to system 100 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized automation rule service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to KanbanBoard456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to KanbanBoard456, and whether the requesting user has read access to the referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations, including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized automation rule service.

FIG. 1B illustrates a simplified diagram of a system that includes a centralized automation rule service. The system shown in FIG. 1B is not necessarily indicative of any particular hardware configurations, but rather is intended to illustrate the operations and functions of various systems, services, and components that facilitate the generation, selection, presentation, modification, and other techniques associated with automation rule templates.

The centralized automation rule service 112 (also referred to simply as automation rule service 112) may interact with a client device, such as the client device 104. The client device may instantiate a graphical user interface 124, which may be a graphical user interface of a collaboration platform. The graphical user interface 124 may be configured to display an automation rule suggestion interface 126, as described herein.

As described herein, the automation rule service 112 may generally provide functions relating to determining when to display, to a user, an automation rule suggestion interface that includes a suggested automation rule template. The automation rule service 112 may further facilitate the modification and/or customization of a rule instance corresponding to the automation rule template, and store the rule instance. The automation rule service 112 may monitor the operations and functions of various systems and services in a collaboration platform (and/or associated systems and services) to identify when trigger criteria of automation rules are satisfied, and to execute the automation rules in response.

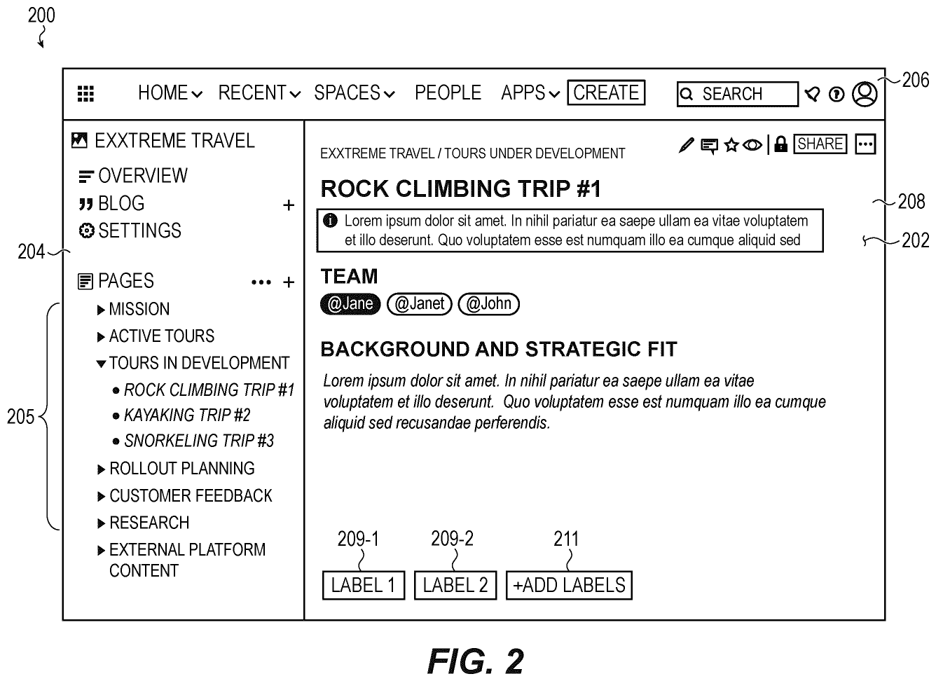

The automation rule service 112 may interface with a content collaboration platform (or other service) that is associated with a graphical user interface that is displayed to a user. The graphical user interface of the content collaboration platform may include an editor panel configured to receive user-generated content for an electronic document, and a navigation panel displaying a hierarchical element tree having a set of elements selectable to cause display of a respective electronic document. Examples of a graphical user interface of a content collaboration platform are shown, for example, in FIGS. 2-14. In other examples, the automation rule service 112 may interface with other services or platforms that provide different functionality and/or have different graphical user interfaces. In any case, the automation rule service 112 may determine, based on a user's real-time interactions with the graphical user interface, when to prompt the user with an automation rule suggestion interface.

For example, in response to a first user input to the graphical user interface (e.g., a particular user interaction with the graphical user interface or a request to initiate a particular action of the content collaboration system), the automation rule service 112 (e.g., with the prompt criteria service 128) may determine whether to provide a recommended automation rule template to a user. The determination may be based at least in part on whether a system use condition associated with the authenticated user satisfies a prompt criteria. The prompt criteria may include various factors that determine whether an automation rule template should be recommended to a user in response to a particular actuation. A system use condition may correspond to particular actions that have been taken, by the user, related to automation rules. For example, a system use condition may satisfy a prompt criteria when the user has not created an automation rule from an automation rule suggestion interface within a time window, or when the user has not dismissed an automation rule suggestion within a time window, or when the user has not created an automation rule using an automation rule builder within a time window. In this way, automation rule suggestions may be muted or otherwise not provided to users if their system use indicates a familiarity with and use of automation rules (and the automation rule service more generally), and/or a clear desire not to be provided with suggestions. Other prompt criteria may also be used to determine whether to suggest an automation rule template to a user.

In some cases, one of the prompt criteria for a given automation rule template is whether the user for whom the automation rule template is being selected has sufficient permission to use automation rules. For example, if the user does not have permission to modify documents in a collaboration platform, the prompt criteria may not be satisfied, and the user may not be provided with a prompt.

In accordance with a determination that the system use condition satisfies the prompt criteria, the automation rule service 112 (e.g., with the automation rule suggestion service 130) may select an automation rule template corresponding to an action type of the action associated with the user input. For example, the first user input may correspond to a request to perform an action such as archiving a page, creating an issue, adding a label to a content item, or the like. Accordingly, the automation rule suggestion service 130 may select an automation rule template that corresponds to a same action type as the input that initially triggered the automation rule template suggestion. More particularly, the automation rule suggestion service 130 may select an automation rule template that is configured to generate an automation rule that automatically initiates future actions associated with the same action type. As a particular example, the action initiated by the first user input may include a content item operation with respect to a first content item (e.g., a first document in a collaboration platform), and an automation rule created pursuant to the selected automation rule template may be configured to initiate the content item operation with respect to a second content item different from the first content item (e.g., a different document in the collaboration platform). In this way, the suggestion may be contextually relevant to the user's actual actions and interactions with the collaboration platform, making the suggestions more likely to be accepted by or otherwise useful to the user.

In some cases, additional prompt criteria are used to determine whether a selected automation rule template may be provided to a user. For example, the automation rule service 112 may determine whether a user has permission to access data that would be accessed by each of the automation components of a selected rule template. As another example, the automation rule service 112 may determine whether a user has permission to perform actions that would be performed by each of the automation components of the selected rule template. As another example, the automation rule service 112 may determine whether a user has an account with a software platform that is associated with an automation component of the selected rule template. As another example, the automation rule service 112 may determine whether a user has an account with a third-party service that an automation component accesses in order to provide its functionality (and/or confirm with the third-party service that the user has authorization to access the information/functionality of the third-party service). If any of these additional prompt criteria are not satisfied, the automation rule service 112 will not suggest that automation rule template to the user.

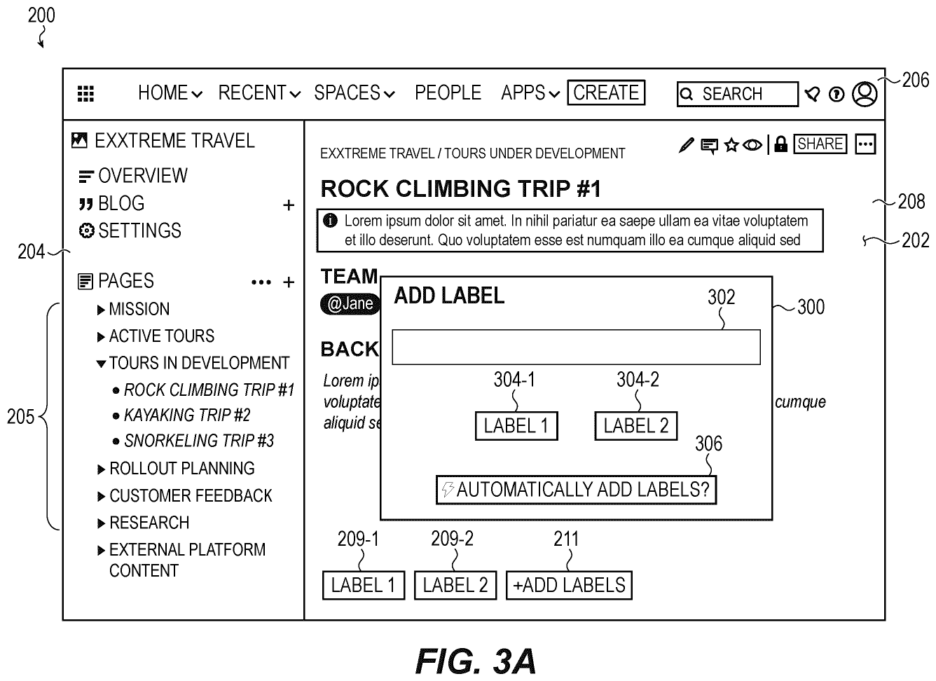

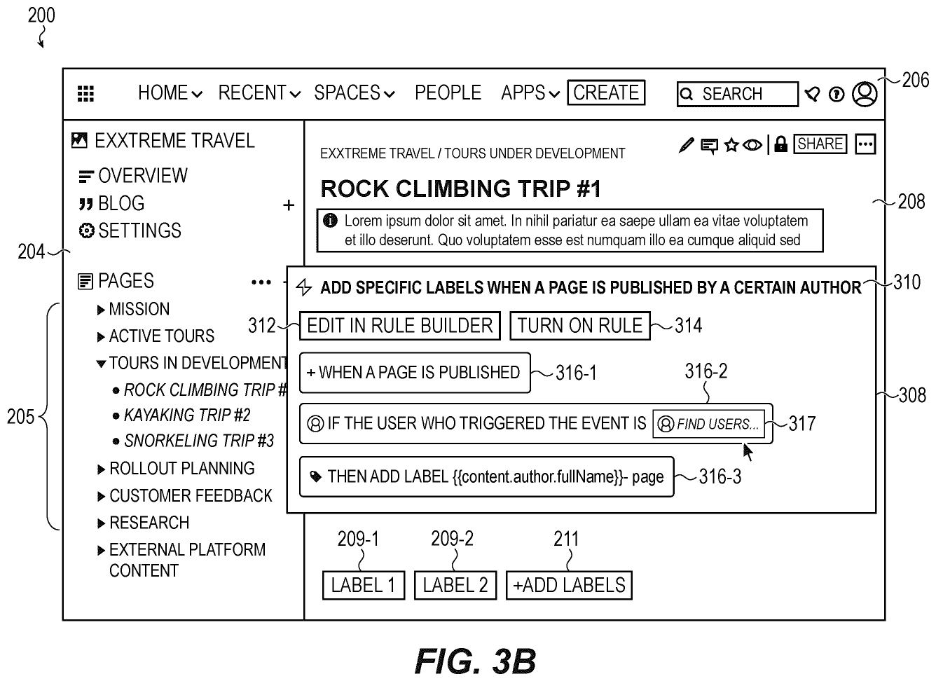

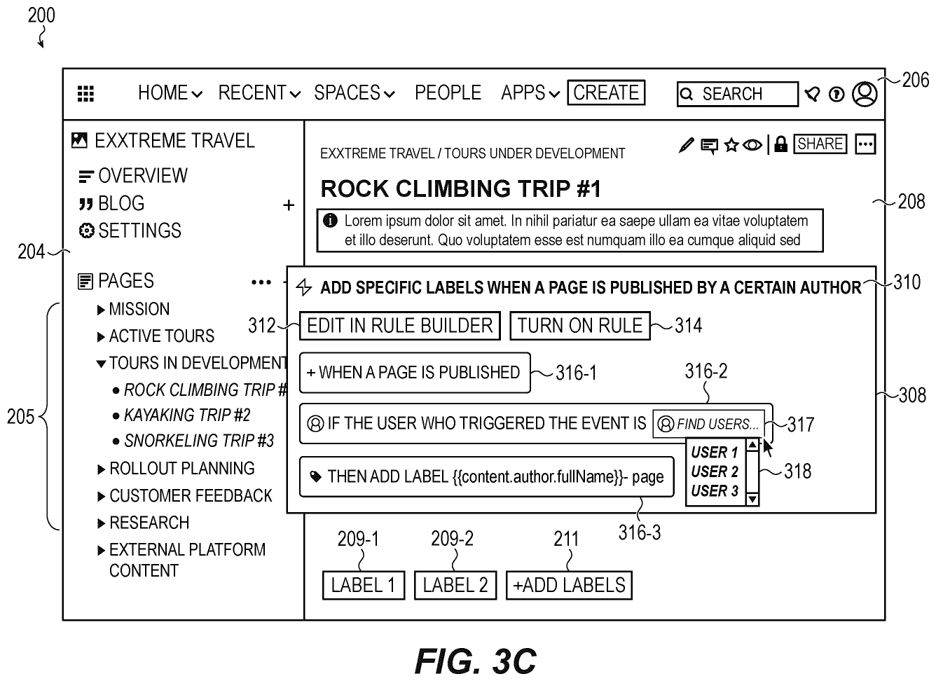

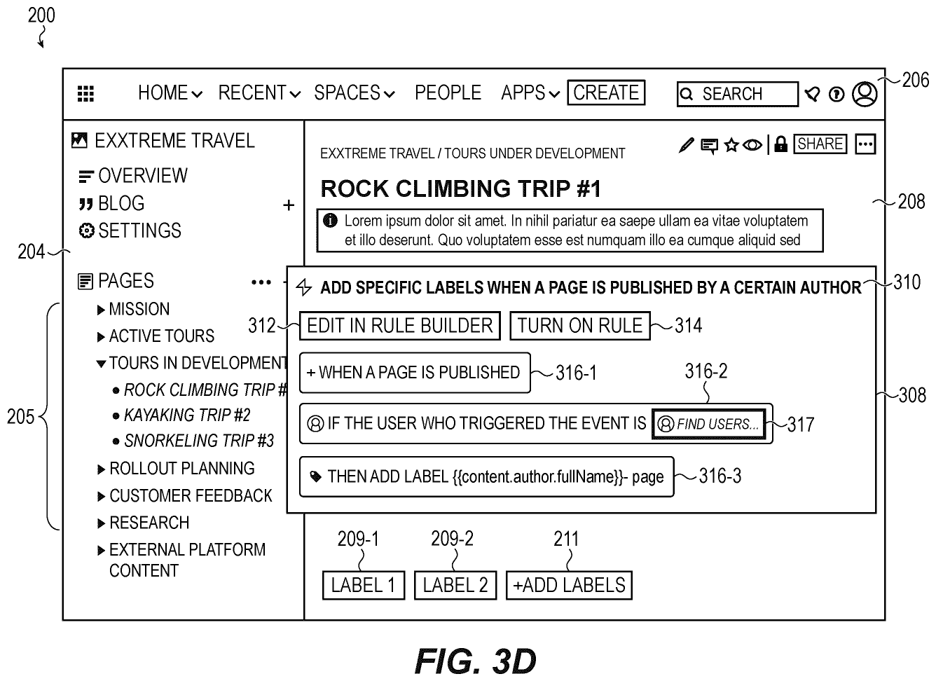

The automation rule suggestion service 130 may cause display of a rule suggestion interface in the graphical user interface of the content creation platform, as described, for example, with respect to FIGS. 3A-5B. The rule suggestion interface may include a set of graphical elements, each respective graphical element of the set of graphical elements corresponding to a respective automation component of the selected automation rule template. More particularly, the selected automation rule template may be defined by or otherwise include one or more automation components. As described herein, the automation components may include components such as a trigger component, an action component, and a condition component. Different automation rule templates may include different sets of automation components. By providing the graphical elements representing the automation components of the template, the user can easily visualize how the suggested automation rule would operate, and can quickly and efficiently decide whether to implement the rule.

As described herein, automation rules may require one or more user selections in order to generate a valid and operational automation rule. For example, an automation rule may include an action component to notify a specified user when a trigger condition is satisfied; an automation rule may include a trigger component that will initiate a rule execution when a particular action is performed by a specified user; or an automation rule may include an action component to move a content item to a specified workspace when a trigger condition is satisfied. In such cases, the automation rule needs a user-specified value (e.g., the specified user or workspace, or any other user-specified value) in order to produce a valid and executable automation rule.

To facilitate efficient automation rule generation and definition, the automation rule suggestion interface may accept user inputs to specify the value. For example, a graphical element representing an action component to notify a specified user may include an input field to receive the user-specified value. The input field may include a list of candidate values that satisfy the particular requirements of the subject automation component. For example, a graphical element for an automation component that requires a user identifier may include a list (e.g., a drop-down list) of candidate user identifiers from which a user can select a particular user identifier. Other types of input modalities are also contemplated, such as direct text input, natural language text input, and the like. Moreover, as described herein, the automation rule suggestion interface may allow users to add or remove automation components, or navigate to a rule builder tool to further customize a rule according to the selected automation rule template.

In response to a user input provided to the rule suggestion interface (e.g., to provide a user-specified value, as described above), the automation rule suggestion service 130 may assign a value to an instance of an automation component associated with a graphical element of the set of graphical elements. Further, in response to a user input to accept or adopt the suggested automation rule (including the user-specified value), the automation rule suggestion service 130 will create a new automation rule instance, the new automation rule having a set of automation components corresponding to the automation components of the automation rule template (and thus corresponding to the set of graphical elements of the rule suggestion interface). The new automation rule may include the instance of the automation component having the assigned value, and any other customizations or modifications provided by the user via the automation rule suggestion interface. The new automation rule may be stored as an automation rule instance in the automation rule storage 136.

The automation rule service 112 may also store automation rules (including instances of automation rules generated by a user via an automation rule suggestion interface), automation rule templates, and may generally facilitate the execution of automation rules. For example, the automation rule service 112 may monitor the various interconnected systems and/or services (e.g., as described with respect to FIG. 1A) that are associated with trigger criteria for the automation rules. In response to detecting an event that satisfies a trigger criteria, the automation rule service 112 may execute the automation rule, including interoperating with any necessary service or system that is used to execute the rule (e.g., sending a request to a collaboration platform to archive a document or add a label to a document, sending a request to an issue tracking system to create a new issue, etc.). In some cases, the automation rule suggestion interface allows users to provide metadata to be stored in association with the rule instance, such as a title, author, description, summary, date of creation, or the like. Accordingly, the automation rule suggestion interface may include a text input field in which a user can supply the text and/or metadata to be stored.

The automation rule service 112 may also include an automation rule validation service 134. The automation rule validation service 134 may perform validation checks for automation rules that are generated by a user, either from an automation rule suggestion interface, or from an automation rule builder, as described herein. The automation rule validation service 134 may determine whether a proposed automation rule satisfies one or more validation criteria. For example, the automation rule validation service 134 may determine whether particular automation components in an automation rule are compatible with one another, and whether all necessary values have been specified for the various automation components. Other validation criteria and validation operations are also contemplated.

In the context of an automation rule suggestion interface, the automation rule validation service 134 may perform a validation operation in response to a user providing an input to accept or adopt an automation rule generated in the automation rule suggestion interface. The validation operation may identify any issues with the automation rule prior to the rule being saved and/or executed in the course of normal operation. For example, if an automation rule suggestion interface proposes an automation rule that requires a user-specified value, but the user does not specify a value, the validation operation may identify that the proposed automation rule does not satisfy the validation criteria, and may provide a graphical or other indication to the user indicating the issue. The user may then be prompted to or otherwise able to correct the issue before finally creating the instance of the automation rule. The automation rule validation service 134 may also perform similar validation operations when a user creates an automation rule in an automation rule builder.

Example validation criteria for automation rules may include, without limitation, a confirmation that all user-specified value fields have been populated with a user-specified value; that each automation component is compatible with the other automation components in the rule; that the order of automation components is valid; that the user has permission to perform the operations specified in the automation rule; that the user has permission to access information that will be accessed when the automation rule is executed; and the like.

As described herein, the automation rule service 112 may be configured to interact or interoperate with third-party services in order to leverage or otherwise provide functionality associated with the third-party service. For example, an action component of an automation rule may be configured to execute an action or operation that is provided by a third-party service. As another example, an automation component may rely on or use data that is provided by a third-party service. In such cases, the automation rule service 112 may issue one or more API calls to the third-party service. In examples where the automation rule service 112 needs information from a third-party service in order to produce a graphical element for an automation rule suggestion interface, the automation rule service 112 may issue an API call after selecting an automation rule template that includes a reference to the third-party service. For example, the automation rule service 112 may issue an API call to a third-party service to retrieve a list of items (e.g., usernames or identifiers, project titles, websites, etc.) that is to be included or displayed in the automation rule suggestion interface. The automation rule service 112 may receive the requested information from the third-party service and include it in the automation rule suggestion interface as appropriate.

As described herein, the automation rule service 112 may use a generative output service 116 to programmatically generate automation rules or portions of automation rules from inputs. For example, the automation rule suggestion interface may include a natural language text input field in which a user can input text to modify or add to a rule generated from a rule template. For example, an automation rule suggestion interface may include an automation rule template (e.g., a proposed rule based on an automation rule template) that will archive a content item if it has not been accessed in over a year. Upon reviewing this suggestion, a user may provide an input to the natural language input field such as “and then inform me that it has been archived” or “archive the content items after 2 years.” The natural language input may be supplied to a model prompt management service 114 (FIG. 1A) which ultimately engages the generative output service 116 to produce a proposed rule that is based on the rule template, but also satisfies the user's additional input (e.g., by adding an automation component or modifying an automation component that was initially suggested).

As described herein, one context in which automation rule templates may be suggested to a user is a content collaboration software platform. FIG. 2 illustrates an example graphical user interface 200 of a content collaboration platform executing on a client device of a user. The graphical user interface 200 may be implemented in a web browser client application using HTML, JavaScript, or other web-enabled protocol. The graphical user interface (GUI) 200 may allow the user to create, edit, or otherwise modify user-generated content that is stored as an electronic document or page (e.g., in a data store associated with the content collaboration platform). The graphical user interface 200 may have various partitions/sections displaying different content. For example, the graphical user interface 200 may include a navigational panel 204, a toolbar 206, and a content panel 208.

The content panel 208 may display the contents of a selected document or other content item, and may allow a user to edit the selected document or content item (e.g., to add, change, or remove content). In general, when an authenticated user has edit permissions with respect to the displayed content, the content panel 208 may operate as a content editor and allow the user to directly add, edit, modify, or otherwise interact with the content of the document or content item. When a user does not have edit permissions, the document or content item may be displayed in a view-only mode, or with only limited ability to add, edit, or otherwise modify the content. The content panel 208 is shown displaying a document 203. The document 203 includes document content, such as text, images, a title, authors or tagged users, and the like. The document 203 may also include labels 209 (e.g., labels 209-1, 209-2). The labels 209 may be user-defined textual information that can be added to or stored in association with a content item.

The navigational panel 204 may include a hierarchical element tree 205 (also referred to herein as a page tree), which may be associated with a particular document space or content space. The hierarchical element tree 205 includes tree elements, which may be selectable to cause display of a corresponding page or document. Tree elements may also be referred to herein as selectable elements. Each tree element shown in the navigational panel 204 may be displayed according to its respective hierarchical relationship to the current electronic document, page, or electronic content being displayed. Further, each tree element in the hierarchical element tree 205 may be selectable. In response to a user selection of a respective element of the hierarchical element tree 205, content of the respective page or document may be displayed in the content panel 208.

The navigational panel 204 also includes items that may be selected in order to cause display of other user-generated content that is outside of the hierarchical element tree 205. Specifically, the navigational panel 204 includes an overview element that is selectable to cause display of space-overview content in the content panel 208, a blog element that is selectable to cause display of one or more respective blog entries in the content panel 208, and a settings element that can be used to access settings associated with the current page being viewed and/or the document space. In some cases, display of the navigational panel 204 may be suppressed or hidden using a control provided in the graphical user interface 200. Additionally or alternatively, the navigational panel 204 may be resized or slid all the way to the side of the graphical user interface in order to hide or suppress display of the navigational panel 204.

The page toolbar 206 may provide, to a user, various control options, including but not limited to, menu controls, document creation controls (e.g., create), a search or query control (e.g., for the user to enter one or more keywords to perform search for electronic documents, pages, or electronic content that may be related to the one or more keywords entered by the user), account or profile access controls, notification indicators, etc. The menu controls may include options for selecting a different document space, viewing recently viewed documents or pages, viewing people associated with the system or respective content, navigating to other applications or user interfaces, launching other applications, or viewing other aspects of the system. The content create element 210 may initiate the creation of content items in the content collaboration system 112-1.

The graphical user interface 200 is an example environment in which users may initiate actions (e.g., by providing inputs to the GUI) that have action types relevant to automation rule templates. For example, users may add or change content in a content item; add or modify labels; move content items within a content space; tag or mention other users in a content item; add links to other content (e.g., issue tickets, codebases, other content items or content spaces); publish or depublish content items; create tasks; assign tasks or issues; or the like. While these examples pertain to a graphical user interface for a content collaboration platform, other types of actions may be performed in the context of a graphical user interface for a different platform. For example, in a graphical user interface for an issue tracking platform, example actions may include creating issues, assigning issues, changing issue statuses (individually or in bulk), advancing issues through a workflow, or the like.

These actions (or other actions not explicitly listed) may be associated with action types that can be related to automation rules, and more particularly, automation rule templates that have been defined in an automation rule service. For example, an action of labeling a page with a particular label may correspond to an action type of page labeling, and an action of archiving a page may correspond to an action type of archiving.

Automation rule templates may be generated for various action types. As described herein, automation rules, or automation rule instances, may be generated according to the automation rule templates. Thus, for example, an automation rule template may define or include a set of automation components that, when instantiated as an automation rule, perform a particular action. As described herein, users may be prompted with suggestions for potentially relevant automation rules based on their activities in a content collaboration platform (or other software platform or service). Thus, when a user performs an action, under certain circumstances, they may be prompted with an automation rule suggestion interface that suggests an automation rule based on an automation rule template that is associated with the user-performed action type.

FIG. 3A illustrates an example of the graphical user interface 200 when a user has performed an action that is associated with an automation rule template, and in which one or more prompt criteria have been satisfied. More particularly, FIG. 3A includes a label creation interface 300, which may be displayed in response to a user selecting the add label element 211. The label creation interface 300 facilitates the creation of labels to add to a content item, and may include suggested labels 304-1, 304-2 (e.g., previously generated labels that a user can select), and a text input field 302 (e.g., to allow custom labels to be generated).

In this case, the label creation interface 300 also includes an automation rule suggestion prompt 306. The automation rule suggestion prompt 306 may be displayed in accordance with a determination that prompt criteria have been satisfied for the particular action or type of action that is being performed by the user. For example, as described above, the prompt criteria may be satisfied when the user has not recently (e.g., within a time window) dismissed the automation rule suggestion prompt for this action and/or rule template, created an automation using an automation rule builder, created an automation for this action and/or rule template, or the like. Other prompt criteria are also contemplated, such as whether the user has the requisite permissions to perform the actions that would be performed by the suggested rule, whether the user has the requisite permissions to access the data that would be accessed by the suggested rule, or the like. As described above, the prompt criteria may be specific to certain actions and action types. Thus, for example, prompt criteria may be satisfied with respect to this particular action type (e.g., adding a label to a content item), but may not be satisfied with respect to another action type (e.g., archiving a content item). Thus, automation rule suggestion prompts may be provided in a granular manner, ensuring that suggestion prompts are relevant and timely, and that users are not inundated with prompts for automations that they are already familiar with.

FIG. 3B illustrates an example of the graphical user interface 200 when a user has selected the automation rule suggestion prompt 306. In response to the user selection of the prompt 306, an automation rule suggestion interface 308 is displayed. The automation rule suggestion interface 308 includes information about an automation rule template from which an automation rule that is relevant to the user's actions may be generated.

The automation rule suggestion interface 308 may include a title 310, a rule activation element 314, and an edit activation element 312. The title 310 may summarize what the proposed automation rule accomplishes, and provides a quick reference for the user.

The rule activation element 314 allows the user to create an instance of the proposed automation rule, based on the automation rule template that is provided in the automation rule suggestion interface 308. For example, in response to a user selection of the rule activation element 314, the automation rule service may generate an instance of an automation rule that is based on the proposed automation rule template (and includes any customizations, modifications, or other user-specified values provided by the user in the automation rule suggestion interface 308).

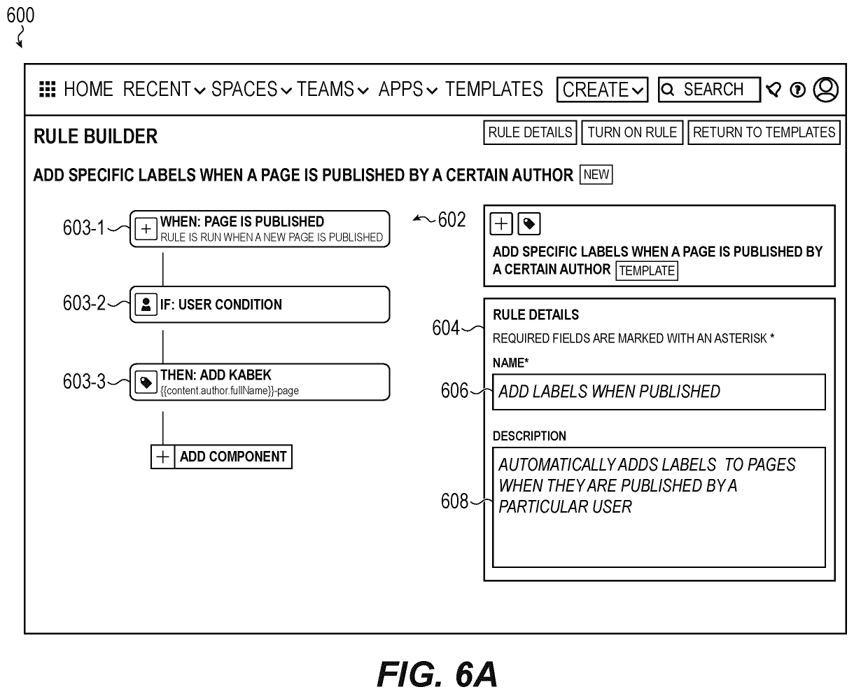

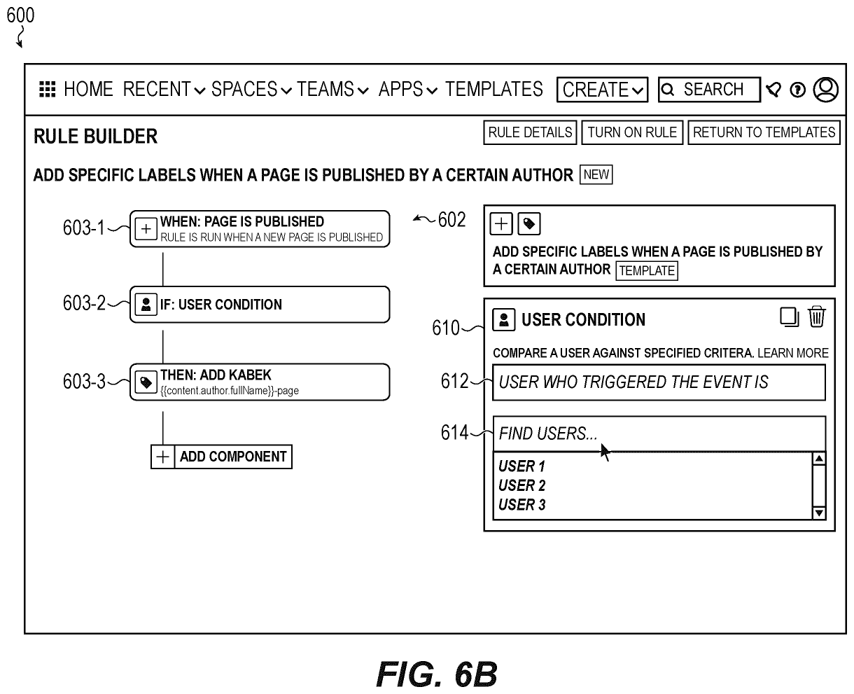

The edit activation element 312 may allow a user to enter an automation rule builder in order to customize or modify the automation rule. In response to a user selection of the edit activation element 312, the automation rule builder user interface may be displayed (as shown in FIGS. 6A-6B). When displayed in response to selection of the edit activation element 312, the automation rule builder may be pre-populated with a rule definition that conforms to the suggested automation rule template, allowing a user to further customize or modify the rule in the environment of the automation rule builder. As described herein, the automation rule builder may provide greater options for customizing or modifying an automation rule than are provided in the automation rule suggestion interface 308.

The automation rule suggestion interface 308 also includes a set of graphical elements 316, each respective graphical element of the set of graphical elements corresponding to a respective automation component of the automation rule template. The graphical elements 316 allow the user to easily and quickly visualize the proposed automation rule, and how the various automation components (e.g., trigger component, action component, etc.) will work together. For users who are not as familiar with automation rules, this also provides a simple introduction to the automation rule system to help them learn the types of automations that the automation rule service is capable of performing.

In some cases, one or more of the graphical elements 316 may require a user-specified value in order to create a valid and operational automation rule. For example, in the automation rule suggestion interface 308, the graphical element 316-2 represents a condition component, where an action is conditioned on a particular user triggering an event. Thus, the automation rule requires a user-specified value (e.g., a user identifier) in order to be a valid and executable automation rule.

In order to provide a simple user experience, the graphical element 316-2 may accept a user input to allow the user to specify the value (e.g., the user identifier). FIG. 3C illustrates the GUI 200 after a user has selected an input field 317 of the graphical element 316-2. In particular, the automation rule suggestion interface 308 includes a list of candidate values 318 displayed in association with the graphical element 316-2. In the example shown, the list of candidate values 318 includes user identifiers corresponding to users of the content collaboration platform. In examples where an automation component requires a different type of value, different values may be displayed in association with a graphical element. For example, a graphical element for an automation component to add a label to a content item may include a list of candidate labels. As another example, a graphical element for an automation component to move a content item to another location (e.g., another space or another position in a hierarchical element tree) may include a list of candidate locations. In some cases, the graphical elements may provide an input field for direct text entry or other value-input or selection methodologies.

As described herein, automation rules may only be effective if they satisfy certain validation criteria. For example, an automation rule that requires a user-specified value to determine when a condition is satisfied may not execute properly if no value has been specified. As another example, an automation rule may not execute properly if it includes automation components that conflict with one another (e.g., incompatible trigger conditions, an action to modify a content item that occurs after deleting the content item, etc.). Thus, in response to a user input requesting creation of a new automation rule according to the automation rule template, the automation rule service may determine whether the new automation rule satisfies the validation criteria (at least with respect to any automation rule component that requires a user-specified value or input). If the new automation rule satisfied the validation criteria (e.g., if the user-specified value has been provided, and/or the automation rule satisfies any other relevant validation criteria), the new automation rule is created and stored for future execution by the automation rule service.

In accordance with a determination that the proposed new automation rule fails to satisfy the validation criteria, a graphical error indication may be provided in the rule suggestion interface in association with the particular graphical element for which the validation criteria has failed. For example, FIG. 3D illustrates the GUI 200 after a user has requested creation of a new automation rule without providing a user-specified value in the graphical element 316-2 (e.g., for the associated automation component). In this case, the input field 317 is shown with a visually distinctive feature (e.g., a bold appearance) and an optional error indicator (e.g., the exclamation mark). Accordingly, before the rule is ultimately created, the user is provided with an indication that the rule is not ready to be created, and an indication of what needs to be done in order to rectify the issue. The particular manner of graphically indicating the error (or validation failure) in FIG. 3D is merely one example, and other techniques may be employed to graphically or otherwise indicate issues with a proposed automation rule instance.

As described herein, automation rule suggestion interfaces may provide a limited set of options to allow users to customize suggested rules. In some cases, the only customization options that are afforded to a user include options to provide user-specified values to automation components that require user-specified values.

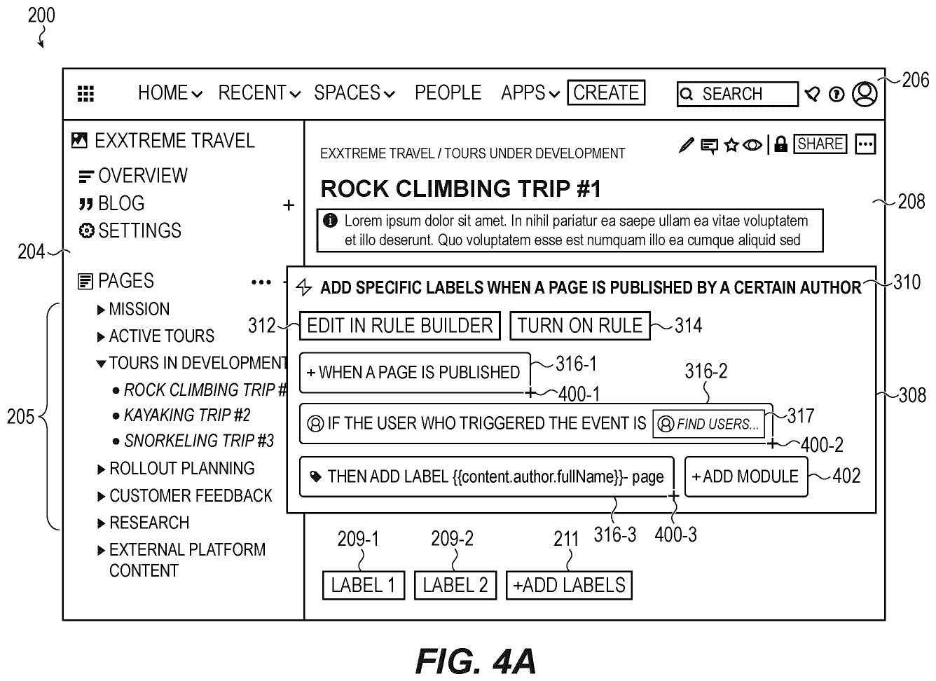

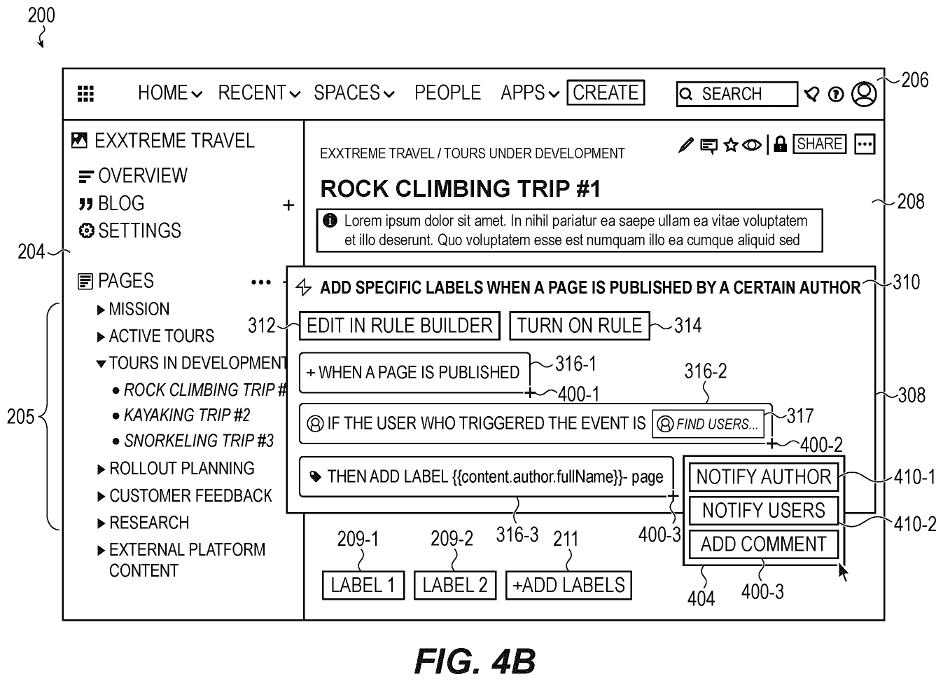

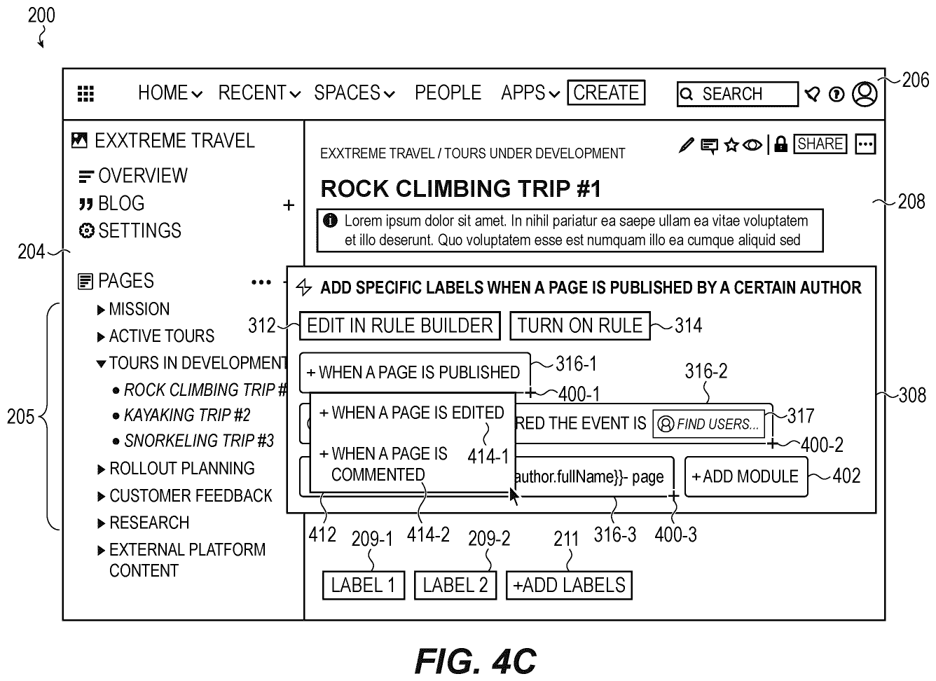

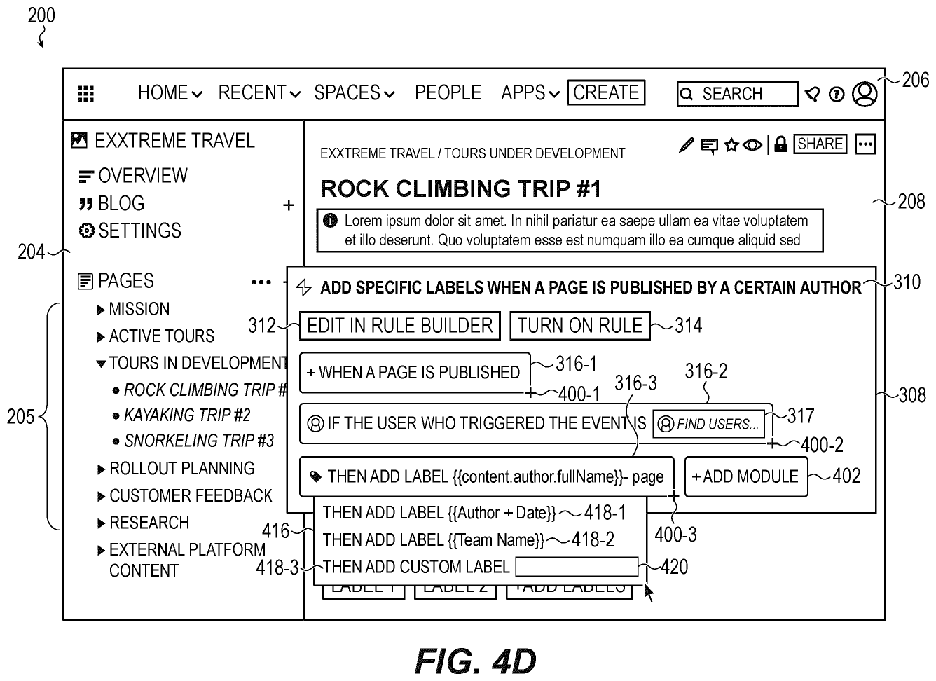

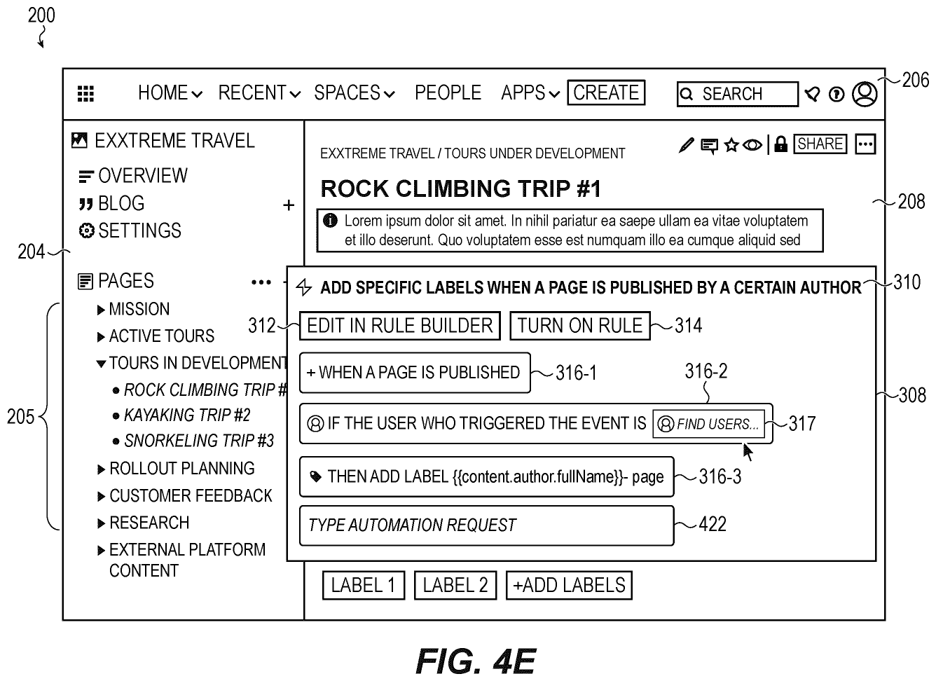

In some cases, more or different options are included in the automation rule suggestion interface. FIG. 4A illustrates an example of the GUI 200 in which the automation rule suggestion interface 308 includes additional modification options. For example, the graphical elements 316 may be associated with selection elements 400 that allow a user to change the automation component at that position in the automation rule. As another example, the automation rule suggestion interface 308 may include an “add module” element 402 that allows a user to add another automation component to the proposed rule.

FIG. 4B illustrates an example of the GUI 200 in response to a user selection of the “add module” element 402. In this example, an automation component selector 404 is displayed, which includes a list of candidate automation components 410 from which a user can choose. The list of candidate automation components 410 may be a list of all automation components that are available, or it may be a subset of the automation components, where the subset includes automation components that satisfy one or more criteria. Example criteria include compatibility with the other automation components in the suggested automation rule, sufficient permissions to use the automation component (e.g., to perform the actions performed by the automation component, access the data accessed by the automation component), existence of a valid user account associated with the automation component, or the like. In some cases, an automation rule template may specify the particular automation components that may be included in the list of candidate automation components.

Upon a user selection of a candidate automation component, a graphical element representing the selected automation component may be displayed in the automation rule suggestion interface 308 and may be appended to or otherwise incorporated into the proposed rule instance (e.g., the proposed rule instance that was defined by the automation rule template). In some cases, the graphical element may be displayed at a location relative to the other elements 316 that corresponds to its logical position in the automation rule. Thus, for example, if the user selects a trigger component, the corresponding graphical element may be positioned at the beginning of the list of graphical elements. In some cases, the graphical elements may be rearranged within the automation rule suggestion interface (e.g., via clicking and dragging elements, or any other suitable input modality). When graphical elements of automation components are rearranged, the rule instance that is created from the automation rule suggestion interface may conform to the user-defined arrangement in the automation rule suggestion interface. As described herein, the automation rule may be subject to one or more validation operations before creation of the rule instance. Accordingly, if a user generates an invalid arrangement of components, the user will be notified. In some cases, the automation rule suggestion interface limits the movement of graphical elements to only compatible positions. Thus, if a user attempts to move an automation component to an invalid position (e.g., an action to move a document after it is deleted), the arrangement will be rejected or otherwise not permitted.

As noted above, an automation rule suggestion interface 308 may include selection elements 400 that allow a user to change an automation component in a proposed automation rule. FIG. 4C illustrates an example of the GUI 200 in response to a user selection of the module selection element 400-1. In this example, an automation component selector 412 is displayed, which includes a list of candidate automation components 414 from which a user can choose. The list of candidate automation components 414 may be a list of all automation components that are available, or it may be a subset of the automation components, where the subset includes automation components that satisfy one or more criteria (as shown). Example criteria include compatibility with the other automation components in the suggested automation rule template, sufficient permissions to use the automation component (e.g., to perform the actions performed by the automation component, access the data accessed by the automation component), existence of a valid user account associated with the automation component, or the like.

In some cases, the automation components in the automation component selector 412 are limited to the same type of automation component as the original automation component. Thus, for example, if a user selects a selection element for a trigger component, the automation component selector 412 will display other trigger components (optionally limited to other triggering components that satisfy any applicable compatibility criteria or other criteria). Similarly, if a user selects a selection element for a condition component, the automation component selector 412 will display other condition components. In some cases, as described above, an automation rule template may specify the particular automation components that may be included in the list of candidate automation components provided for replacing an initial automation component.

Upon a user selection of a candidate automation component, the automation rule suggestion interface may be updated to display the graphical element representing the selected automation component (e.g., in place of the initial graphical element). When automation components are swapped, the rule instance that is created from the automation rule suggestion interface may conform to the new user-defined rule specification in the automation rule suggestion interface. As described herein, the automation rule may be subject to one or more validation operations before creation of the rule instance. Accordingly, if a user selects invalid combinations or arrangements of automation components, the user will be notified. In some cases, the automation rule suggestion interface dynamically limits the automation components that are provided in a component selector based on other automation components currently in the rule specification. Thus, for example, if a user changes one of the automation components in the automation rule suggestion interface, subsequent automation component selectors may be populated only with automation components that are compatible with the new rule definition.

In some cases, a selection element may be used to provide a set of customization options for a given automation component. FIG. 4D illustrates an example of the GUI 200 in response to a user selection of the module selection element 400-3. In this example, an automation component selector 416 is displayed, which includes a list of component customizations 418 from which a user can choose. As shown, the list of component customizations includes various example labels that may be added. More particularly, the list includes examples of predefined labels 418-1, 418-2, and an example of a custom label 418-3 that accepts user-specified values. The user may select a predefined label (which may reference a variable that is populated upon rule execution, such as an author name, date, team name, or other metadata associated with a content item), or the user may supply a user-specified value to be included in the label (e.g., via text entry in the text entry field 420). The text entry field may also be displayed in the automation rule suggestion interface after the custom label option 418-3 is selected.

As described herein, rule specifications that are generated in an automation rule suggestion interface (especially those that are modified by a user) may be analyzed to ensure compliance with one or more validation criteria. As described herein, such validation may be performed while the automation rule suggestion interface is displayed (and optionally in response to a user selection to create the automation rule instance). In this way, the user will be informed of validation errors prior to the rule being created and/or deployed, and can easily correct any errors. In some cases, validation of the proposed automation rules in an automation rule suggestion interface is performed in real-time, as the user is modifying the rule specification (as shown in FIGS. 4B-4D, for example). Thus, for example, if a user adds an automation component or replaces an automation component, and the new component is not compatible or otherwise causes the proposed rule to fail a validation criteria, a graphical indication may be provided to the user in the automation rule suggestion interface. The graphical indication may be provided as a result of the selection of the new/modified automation component, and may not even require the user to select an option to create the automation rule.

As described above, a generative output service may be used in conjunction with the automation rule service in order to allow users to customize or modify a proposed automation rule in a simple and straightforward manner. FIG. 4E illustrates an example of the GUI 200 in which a natural language input field 422 is included in the automation rule suggestion interface 308. The natural language input field 422 may accept natural language inputs (e.g., text inputs) from a user, and may provide the natural language input (along with other information, as described herein) to the generative output service 116 (via the model prompt management service 114). The generative output service 116 may generate one or more proposed rule specifications that may be used to generate an automation rule instance, as described herein.

In some cases, the automation rule service may provide as input to the model prompt management service, information about the automation rule template that was displayed in conjunction with the natural language input field 422 as well as the user's natural language input. In this way, the output from the generative output service 116 may account for both the user's request, as well as the context in which the user's request was provided. As an example, the input to the model prompt management service 114 may include information about each of the automation components from the automation rule template displayed in the automation rule suggestion interface 306 (e.g., titles, descriptions, etc.), as well as the user's input. Thus, the output from the generative output service 116 may include a rule specification that includes or is based on the initial automation rule template, but also includes the modification, customization, or addition requested by the user. For example, if the user provides an input to the natural language input field of “also add a label with the name of the parent project,” the generative output service 116 may return a rule specification that includes the automation components in the initial template, as well as an additional automation component that will add a label to the content item with the name of the parent project. As another example, if the user provides an input to the natural language input field of “run this when a page is edited,” the generative output service 116 may return a rule specification that includes the automation components in the initial template, but with the original trigger component replaced with a new trigger component to run the automation rule when the page is edited.

The results from the generative output service 116 may then be used as the automation rule specification for the automation rule suggestion interface 308, and may be subjected to validation operations as described herein. In some cases, the automation rule suggestion interface 308 updates the displayed graphical elements in response to the results from the generative output service 116 to display to the user an accurate representation of the currently configured automation rule specification. Accordingly, a user can review the automation rule specification and provide further modifications if necessary. Additionally, the results from the validation operation, including any validation or other errors, may be indicated in the automation rule suggestion interface 308 in conjunction with the modified automation rule specification, thus allowing the user to make any further modifications or corrections before instantiating the automation rule.

In some cases, the natural language input field may be displayed in conjunction with the automation rule specification that was provided by the generative output service, thereby allowing the user to provide further inputs to the generative output service. Additional inputs to the natural language input field may be provided to the generative output service (via the model prompt management service), along with information about previous requests or inputs to the generative output service. In this way, the generative output service may provide results that are contextually relevant to an ongoing interaction with the user. For example, if a generative output service provides a rule specification that does not satisfy a user, the user may provide an input such as “undo that” or “change the order of those labels,” and the generative content service can provide an appropriate response that takes into account the earlier interactions with respect to the automation rule specification.

FIGS. 3A-4E illustrate examples in which an automation rule template is selected for a user in response to a user action, and the automation rule template is configured to generate a rule that initiates further instances of that action. For example, a rule template for adding labels to a content item is selected in response to detecting a user adding a label to a content item. Other example actions and action types may result in other automation rule templates being selected for suggestion to a user. For example, if a user archives a content item, a content item archiving automation rule template may be suggested; if a user tags another user in a content item, a user tagging automation rule template may be suggested; if a user links to an issue record of an issue tracking platform, an issue linking automation rule template may be suggested. In this way, automation suggestion prompts, and more particularly, the particular automation suggested in a prompt, may be directly linked to a similar action that was performed by the user.

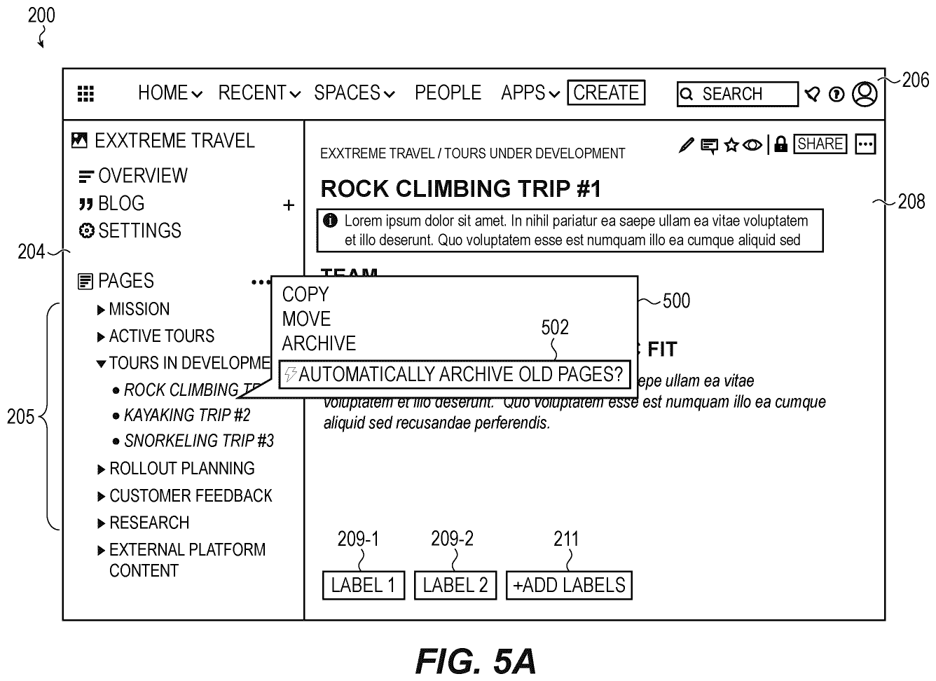

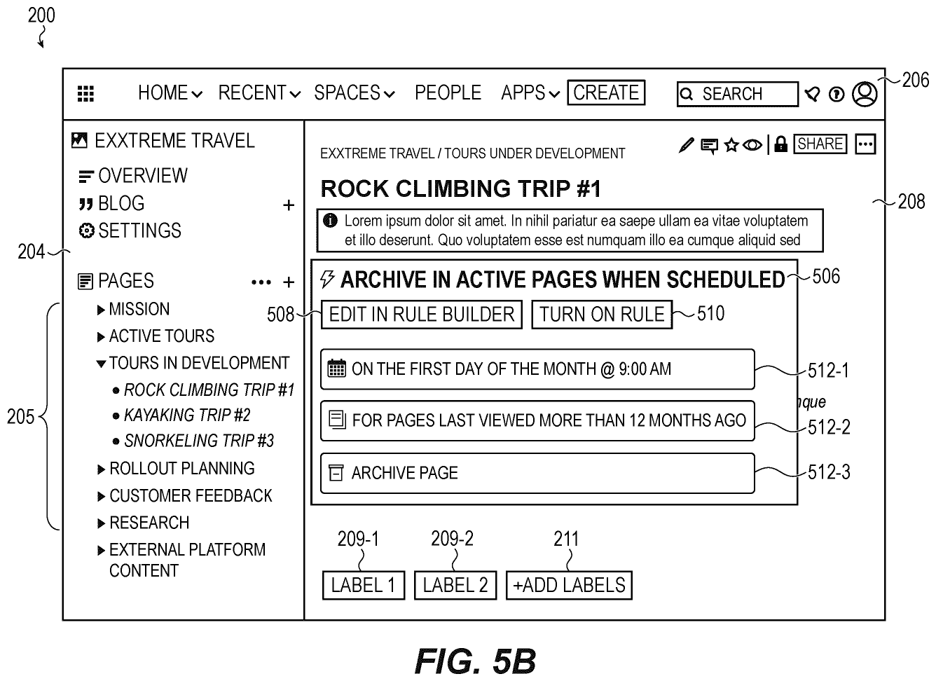

In some cases, prompts that suggest automation rules (and that include automation rule templates) may be provided in other contexts and/or in other areas of a graphical user interface. For example, prompts may be displayed near affordances that are used to select or initiate certain actions, and the prompts that are displayed may relate to automation rules that are relevant to those same actions. FIG. 5A illustrates an example of the GUI 200, illustrating a menu object 500 (e.g., a context menu, popup menu, etc.) that may be displayed in response to a user interaction with a selectable element in a hierarchical element tree 205. The selection may correspond to a mouse click (e.g., a right click), a cursor hover, or the like.

The menu object 500 may include a set of actions that may be performed with respect to one or more content items (e.g., copy, move, archive, etc.). If prompt criteria are satisfied for a particular automation rule or content item action, the menu object 500 may also include an automation rule suggestion prompt 502. The automation rule suggestion prompt 502 may be related to at least one of the actions in the menu object 500, thus maintaining the contextual relevance of the rule suggestion prompts to the user's actual interaction with the software platform. In this example, the menu object 500 includes an “archive” action, and the automation rule suggestion prompt 502 relates to an automation rule template for archiving pages.

FIG. 5B illustrates an example of the GUI 200 in response to a user selection of the automation rule suggestion prompt 502. In particular, in response to the user selection of the prompt 502, an automation rule suggestion interface 504 is displayed. The automation rule suggestion interface 504 includes information about the automation rule template associated with the automation rule suggestion prompt 502.

The automation rule suggestion interface 504 may include a title 506, a rule activation element 510, and an edit activation element 508, which may operate in the same or similar manner as the corresponding elements described with respect to the automation rule suggestion interface 308.

Additionally, the automation rule suggestion interface 504 includes a set of graphical elements 512, each respective graphical element of the set of graphical elements corresponding to a respective automation component of the automation rule template. The graphical elements 512 allow the user to easily and quickly visualize the proposed automation rule, and how the various automation components (e.g., trigger component, action component, etc.) will work together. As shown in FIG. 5B, the graphical elements 512 (and the automation rule suggestion interface 504 more generally) do not provide options for customizing the automation components. In other examples, such options (e.g., as described with respect to FIGS. 3B-4E) are provided in the automation rule suggestion interface 504.

As described herein, the automation rule suggestion interfaces in which proposed automation rules are presented to a user may include edit activation elements that, when selected, cause an automation rule builder or other editing interface to be displayed. FIGS. 6A-6B illustrate an example automation rule builder 600 that may be displayed in response to a user selection of the edit activation element 508 in FIG. 5B. The automation rule builder 600 may include a rule preview region 602 that displays graphical elements 603 corresponding to the currently specified automation components from the automation rule suggestion interface. Thus, for example, if the user selects the edit activation element when the automation rule template is displayed in the automation rule suggestion interface, the components of the automation rule template are prepopulated in the rule preview region 602.

The automation rule builder may allow greater customization and modification options than are afforded in an automation rule suggestion interface. As one example, the automation rule builder may provide a metadata region 604 that allows users to add metadata to the rule instance that will be created from the automation rule specification. For example, the metadata region 604 may include a title input region 606 and a description input region 608. This user-supplied data may be stored in conjunction with a rule instance that is generated from the automation rule template (and/or any automation rule specification), and may allow the user to easily organize, locate, or share, the automation rule instance.

As shown in FIG. 6B, the automation rule builder may allow the user to customize, modify, edit, or otherwise manipulate the prepopulated automation rule specification. For example, automation rule builder allows users to add automation components, remove automation components, rearrange automation components, or the like. In some cases, a user can highlight or select an automation component in the rule preview region 602 to cause an automation component editing interface 610 to be displayed. The interface 610 allows the selected automation component to be customized, such as to provide a user-specified value for the component. As shown in the example of FIG. 6B, the interface 610 relates to the selected condition component 603-2, and includes a first selection element 612 to select a particular condition for the condition component 603-2, and a second selection element 614 to select a value for the selected condition. Other types of automation components may be associated with other data, fields, selection options, and the like, that are displayed in the editing interface 610.

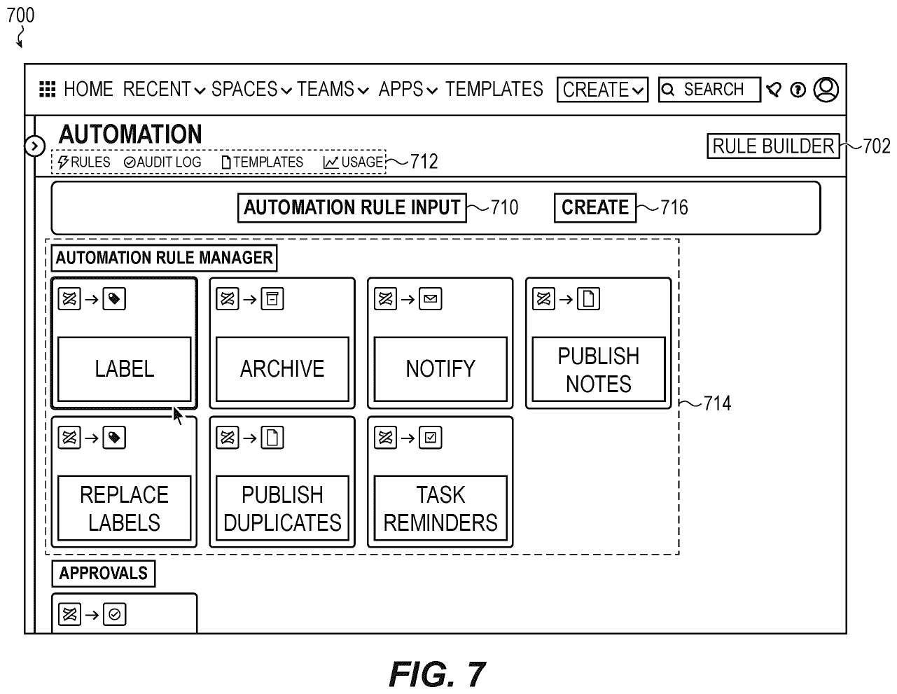

FIG. 7 depicts another example frontend interface 700 that supports automation rule creation for collaboration platforms, in accordance with aspects described herein. The frontend interface 700, which may also be referred to as a UI or GUI, may be an example automation rule builder in which users can build automation rules. In some cases, the frontend interface 700, or portions thereof, may be used to facilitate modifying or customizing automation rules based on automation rule templates that are provided in user prompts, as described herein. In some cases, the frontend interface 700 may be used to generate automation rule instances from scratch, and/or to generate automation rule templates that are used to populate an automation rule suggestion interface, as described herein.

The frontend interface 700 can be rendered by a client device 104 or a client device 106, which may be a personal electronic device such as a laptop, desktop computer, tablet and the like. The client device can include a display with an active display area in which a user interface, e.g., frontend interface 700 can be rendered. The user interface can be rendered by operation of an instance of a frontend application associated with a backend application that collectively define a software platform as described herein.

More particularly, as described with reference to system 100, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

As shown, frontend interface 700 includes rule builder button 702, a text input field 710, selectable tabs 712, a display area 714, and a create button 716. Text input field 710 is field configured to accept textual inputs, for example a natural language rule for the creation of automation rules. The create button 716 can be used to submit the textual input in the text input field 710 for creation of an automation rule by the system 100, for example using or aided by a generative output service.

In one or more embodiments, selectable tabs 712 include tabs for “rules,” “an audit log,” “templates,” and “usage,” each of which may cause a different display to appear in display area 714. Selecting the rules field causes the display area 714 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 714. Examples of such automation rules include a “label” rule (e.g., adding a specific label when a page is published by a certain author), an “archive” rule (e.g., archiving inactive pages when scheduled (recurring)), a “notify” rule (e.g., notifying certain people about inactive pages when scheduled (recurring)), a “publish notes” rule (e.g., publishing new meeting notes page when scheduled (recurring)), a “replace labels” rule (e.g., replacing a label on all pages when scheduled (recurring)), a “publish duplicates” rule (e.g., publishing the same set of pages when a new space is created), and a “task reminders” rule (e.g., reminding teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 714 that includes templates that a user may utilize to create automation rules from a template. Such templates provide a predefined structure for common automation rules that a user may want to use in the manual creation of an automation rule.

In one or more embodiments, selecting the audit log tab may cause a display to appear in display area 714 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 714 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rules, including automation rules generated from using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

In one or more embodiments, the rule builder button 702 may be selected by a user to direct the frontend interface 700 to a rule builder that can be leveraged by a user to generate automation rules from components with assistance from graphical elements, as further described herein.

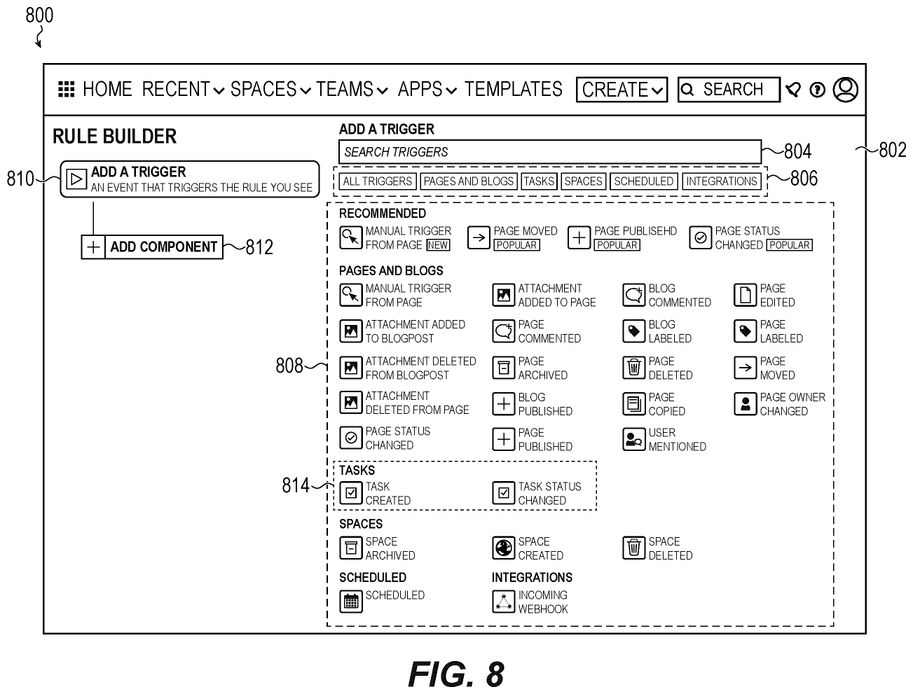

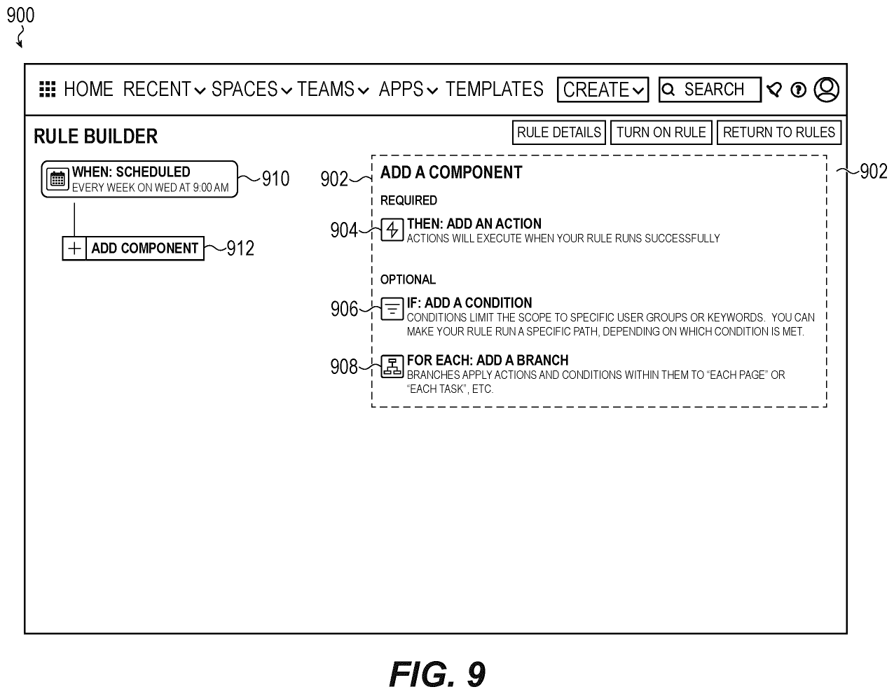

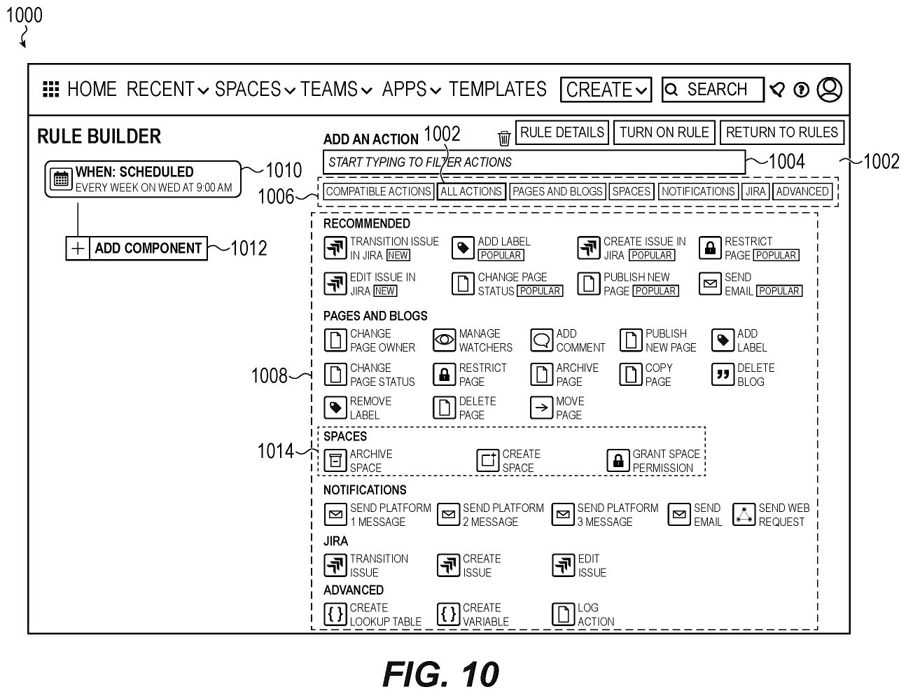

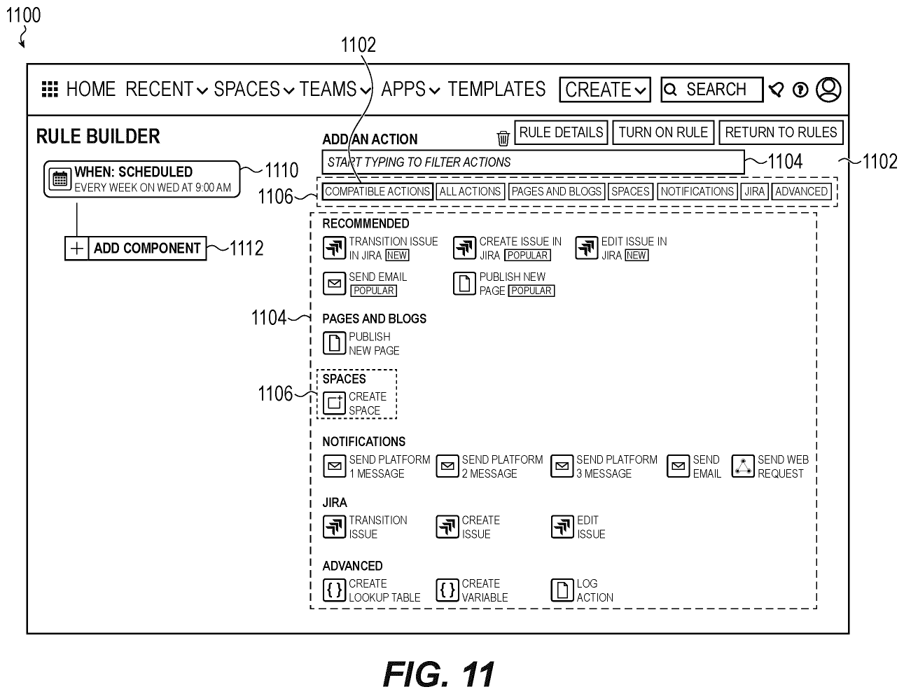

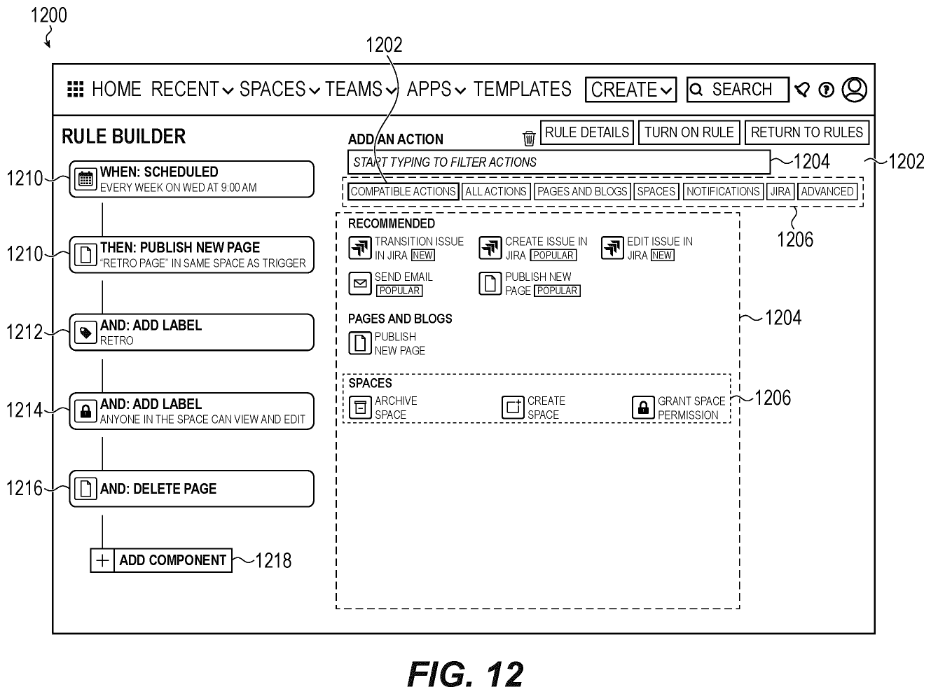

FIGS. 8-12 generally depict frontend interfaces in an example of a flow to generate an automation rule. FIG. 8 generally depicts the selection of a trigger component for an automation rule flow. FIG. 9 generally depicts required and optional component categories for a user to select to display additional automation rule components to add to the automation rule flow, incorporating the previously-selected trigger component. FIG. 10 generally depicts the selection of an action component for an automation rule flow, incorporating the previously-selected trigger component, where all action components are displayed. FIG. 11 generally depicts the selection of an action component for an automation rule flow, where only compatible action components are displayed. FIG. 12 generally depicts the selection of an action component for an automation rule flow, where only compatible action components are displayed, and a number of action components have already been added to the automation rule flow (e.g., narrowing or limiting the number and/or type of compatible action components).

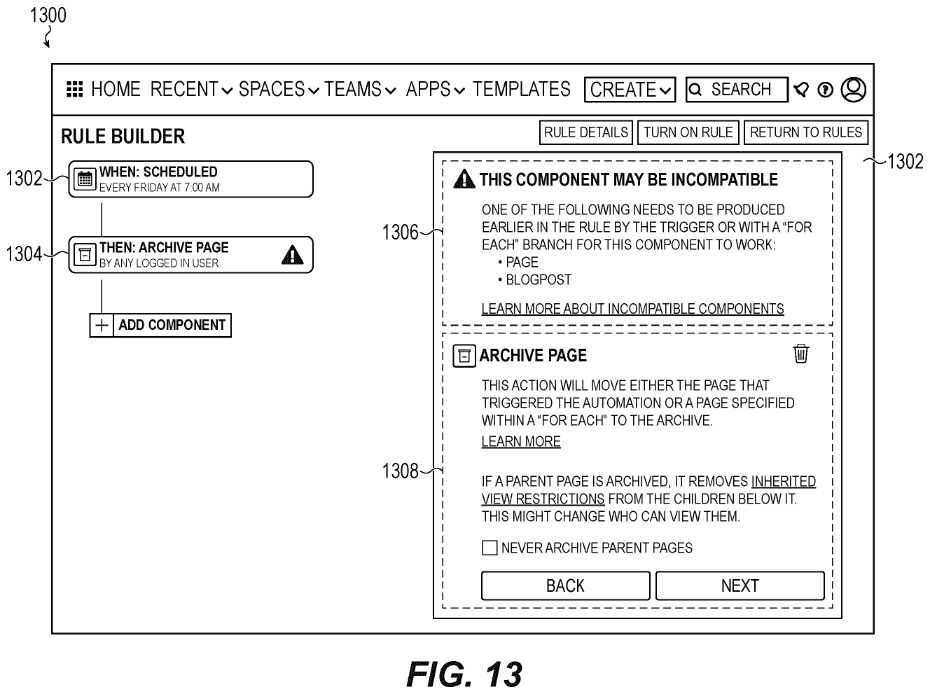

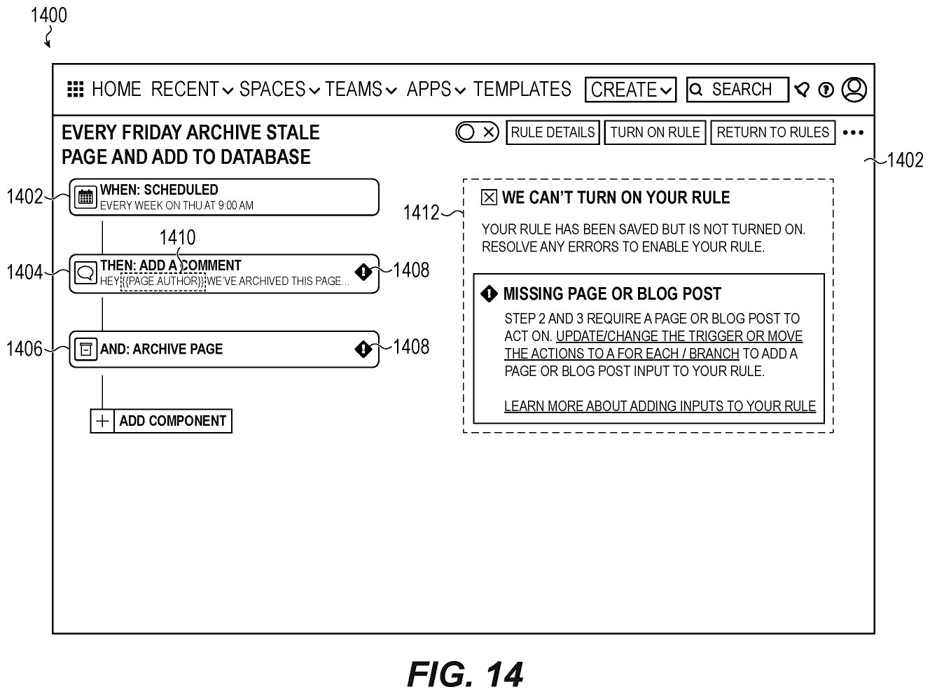

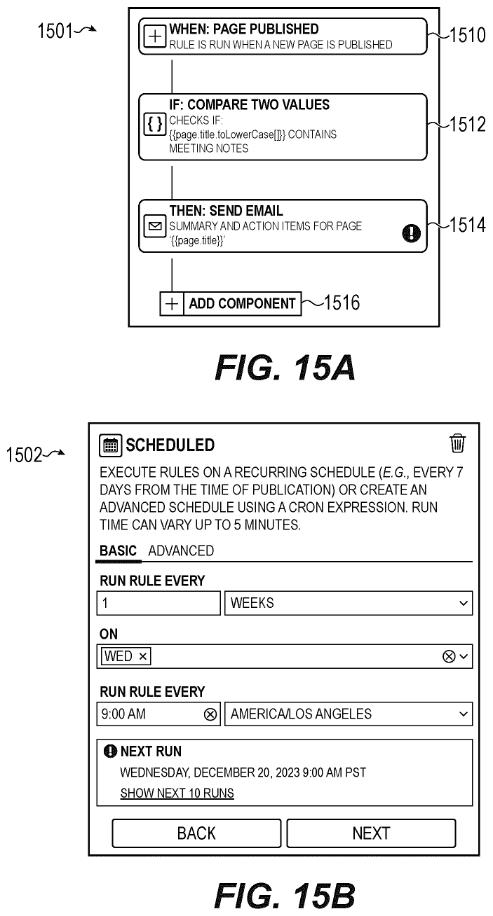

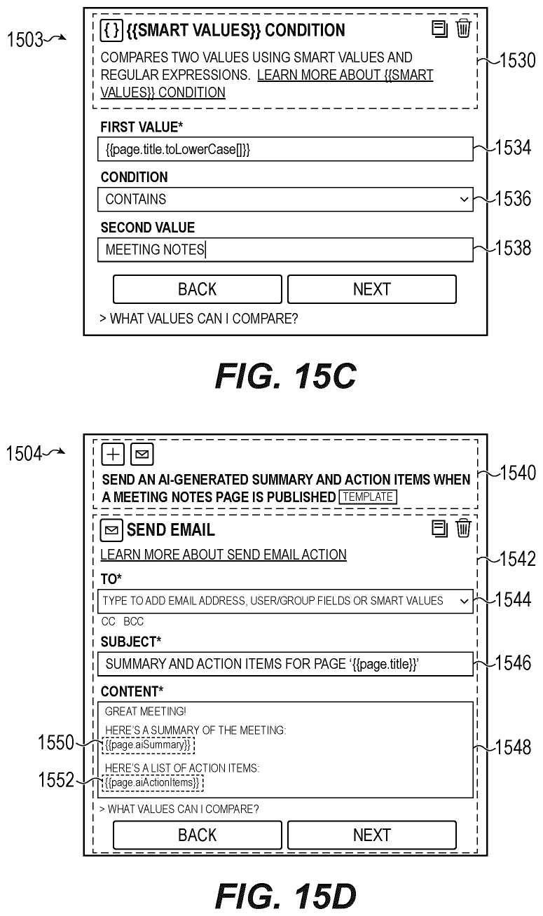

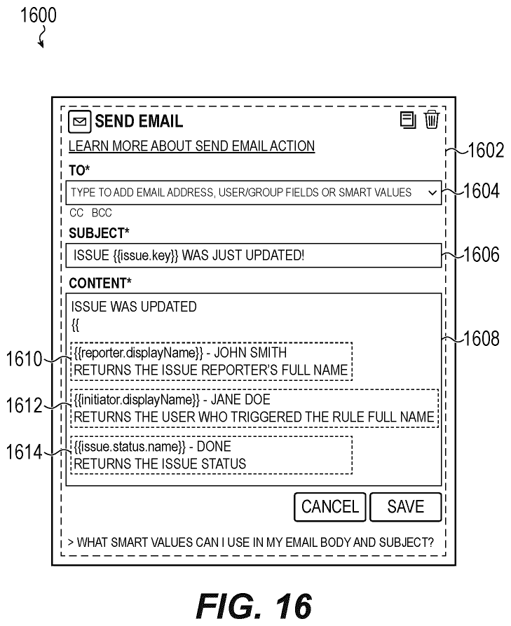

FIGS. 13-16 generally depict examples of special cases and additional features of frontend interfaces. FIG. 13 generally depicts an example of a GUI of a rule builder in the case of a potential incompatibility between one or more automation rule components, such as while creating the rule or during validation. FIG. 14 generally depicts another example of a GUI of a rule builder in the case of a potential incompatibility between one or more automation rule components, such as while creating the rule or during validation. FIGS. 15A-15D generally depict examples of windows for the provision and modification of parameters and other values for automation rule components, including the use of dynamic text references (e.g., “smart values”). FIG. 16 generally depicts an example of a window for the provision and modification of parameters where dynamic text references may be suggested.

FIG. 8 depicts an example frontend interface 800 that supports automation rule creation for collaboration platforms, in accordance with aspects described herein. Frontend interface 800 may also be referred to as a UI or GUI. In one or more embodiments, frontend interface 800 may be displayed at a same display or interface as frontend interface 700, for example rendered in response to a user selecting the rule builder button 702. The frontend interface 800 displays the rule builder 802, which includes graphical elements to assist a user in generating an automation rule to operate in a collaboration system (e.g., system 100), as further described herein. In some embodiments, rule builder 802 may be at least a part of a GUI that is rendered by one of first platform backend 108 or second platform backend 110.

In one or more embodiments, rule builder 802 may include a proposed automation flow (or workflow) region and a control region.

Generally, the proposed automation flow region includes graphical elements representing automation rule components. In some examples, the graphical elements representing automation rule components may be replaced during rule building with graphical elements representing selected automation rule components. For example, the proposed automation flow region may include a trigger adding button 810 that may be replaced by a graphical element representing a selected trigger component, and a component adding button 812 that may be replaced by a selected action component. The proposed automation flow region may expand or contract as automation rule components (and their respective graphical elements) are added or deleted.

Generally, the control region may include a search box for automation rule components, tabs for categories of those automation rule components, and graphical elements representing selectable automation rule components.

In one or more embodiments, the rule builder 802 of the frontend interface 800 may include a search box 804, a set of tabs 806, and a set of trigger components 808 in the control region, and a trigger adding button 810 and a component adding button 812 in the automation workflow region. Frontend interface 800 illustrates a simplified view. In some embodiments, rule builder 802 may be embedded within another GUI (e.g., window), or include one or more additional textual and/or graphical elements not shown with reference to frontend interface 800.

The search box 804, the set of tabs 806, and the set of trigger components 808 may be rendered and displayed to a user, for example responsive to the user initiating (starting, entering) the rule builder 802 and selecting the graphical element that is the trigger adding button 810. In some embodiments, after selecting a trigger components for an automation rule, a user may select the graphical element that is the add a component, button 812. In other embodiments, a user may select the graphical element that is the add a button 812 before selecting the trigger component.

The set of trigger components 808 include trigger components that may be used to initiate an automation rule based on an event. In some embodiments, the triggers may be organized into one or more groups or subsets of triggers components. In the example of the frontend interface 800, the groups include recommended, pages and blogs, tasks, spaces, scheduled, and integrations. In this example, the recommended triggers include a manual trigger from a page, a page moved, a page published, or a page status changed. The pages and blogs triggers include a manual trigger from a page, an attachment added to a blogpost, an attachment added to a page, an attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. The tasks triggers include task created and task status changed. The spaces triggers include space archived, space created, or space deleted. The scheduled triggers include a scheduled trigger. The integrations triggers include an incoming webhook trigger.

In one or more embodiments, the recommended triggers of the set of trigger components 808 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, the generative output service 116 may be trained on the usage of trigger components for automation rules within a platform or set of platforms, and be used to determine the recommended trigger components based on one or more inputs and a list of potential or candidate trigger components. In some examples, the generative output service 116 can receive (e.g., from the centralized automation rule service 112) information regarding a history of trigger component selections (e.g., for a particular user, group of users, particular platform, or by other groupings), and this information may be used by the generative output service 116 to provide (e.g., from the centralized automation rule service 112) an indication (e.g., suggestion or recommendation) for a trigger component or set of trigger components 808 (e.g., as the “recommended” trigger components) as part of automation rule building and creation.

The trigger groups for the set of trigger components 808 may be selectable via the set of tabs 806. For example, by selecting the “tasks” selectable element, the set of trigger components 808 may be pared down to display only the associated task triggers 814 (e.g., task created and task status changed), and the other available trigger components are hidden.

Search box 804 accepts textual inputs from a user, and in response, the rule builder 802 can filter the set of trigger components 808. In some embodiments, the displayed set of trigger components 808 may be pared down such that only trigger components that satisfy the search are displayed (and other, non-responsive trigger components hidden). In other embodiments, a drop-down or pop-up may be displayed that includes selectable trigger components that satisfy the search.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

FIG. 9 depicts an example frontend interface 900 that supports automation rule creation for collaboration platforms, in accordance with aspects described herein. Frontend interface 900 may be an example of frontend interface 800 following selection by a user of the trigger components 808 that are scheduled.

In one or more embodiments, rule builder 802 of the frontend interface 900 may include a component addition box 902 that indicates required and option components for an automation rule. In particular, in addition to a trigger component, an automation rule requires at least one action component. Action components are automation rule components that will execute if the automation rule runs successfully (e.g., based on a detected triggering event). As such, a selectable graphical element for an action component 904 is displayed. Upon selection (e.g., via point click or double-click, or drag and drop to the add component graphical element, such as button 812), action components may be displayed in the rule builder 802 as further discussed herein.

Optionally, an automation rule may use one or more additional components, such as conditions or branch components. As such, component addition box 902 may also include selectable graphical elements for a condition component 906 and a branch component 908.

Condition components are automation rule components that limit the scope of the automation rule to specific user groups or keyworks. For example, a condition may limit a rule to run on a specific path, depending on which condition is met (satisfied). In one or more embodiments, there is a single event condition. In other embodiments, multiple event conditions are used, and may be set to occur at any point within the automation rule chain. In some embodiments, event condition(s) are in if-then or if-then-else form. In one or more embodiments, examples of event conditions include a user, a database query (e.g., a Confluence querying language (CQL)), such as a query in the form of an “if” statement for the content of a page, blog, comment, or attachment, a compare, an if-else statement, or a combination of these. In some embodiments, these conditions are for a documentation platform.

In one or more embodiments, examples of event condition(s) include compare functions, which may be values or regular expressions. In one or more embodiments, values for a compare function may include one or more of an issue, conditional logic, users, test fields, date and time, JavaScript Object Notation (JSON) function, math expression, list, or a combination of these. In some embodiments, these conditions are for an issue tracking platform.

Branch components are automation rule components that apply actions and conditions within each branch to each task, each page, and so on. In some embodiments, a branch component is similar to a “for each” requirement.

FIG. 10 depicts an example frontend interface 1000 that supports automation rule creation for collaboration platforms, in accordance with aspects described herein. Frontend interface 1000 may be an example of frontend interface 800 following selection by a user of the scheduled trigger component from the set of trigger components 808, or frontend interface 900 following selection by a user of the graphical element for the action component 904. The frontend interface 1000 displays the rule builder 802, which now includes elements to allow the addition of an action to the automation rule being create and built.

While FIG. 10 generally depicts the selection of an action component for an automation rule flow where all action components are displayed, FIG. 11 more specifically depicts the selection of an action component where only compatible action components are displayed.

In one or more embodiments, rule builder 802 of the frontend interface 1000 may include a search box 1004, a set of tabs 1006, and a set of action components 1008. Frontend interface 1000 illustrates a simplified view. In some embodiments, rule builder 802 may be embedded within another GUI (e.g., window), or include one or more additional textual and/or graphical elements not shown with reference to frontend interface 1000.

Generally, each action component of the set of action components 1008 indicates the action to be performed following the trigger component 910 and, if present, if the event condition of the automation rule is met. The action indicates the object on which the action is performed. Actions are what the automation rule is to do or, stated differently, what happens if the automation rule executes successfully.

In some embodiments, the set of action components 1008 may be organized into one or more groups or subsets of action components. In the example of the frontend interface 1000, the groups include recommended, pages and blogs, spaces, notifications, Jira (e.g., an example of an issue tracking system), and advanced. In this example, the recommended actions include a transition an issue in Jira, edit an issue in Jira, add a label, change page status, create issue in Jira, publish a new page, restrict a page, or send an email. The pages and blogs actions include adding a comments, adding a label, archiving a page, change a page owner, change a page status, copy a page, delete a blog, delete a page, manage watchers, move a page, publish a new page, remove a label, or restrict a page. The spaces actions include archiving a space, creating a space, or granting space permissions. The notifications actions include sending an email, sending a message through a first platform (e.g., a Microsoft Teams message), sending a message through a second platform (e.g., a Slack message), sending a message through a third platform (e.g., a Twilio notification), or send a web request. The Jira actions include transitioning an issue, editing an issue, or creating an issue. The advance actions include creating a lookup table, creating a variable, or logging an action.

In one or more embodiments, the recommended action components may be based on a usage history for the user, such as the quantity of uses for the action component exceeding a threshold value or the user's most used trigger components (e.g., ten most used action components). In other embodiments, the recommended actions are based on the quantity of uses by a group of users (e.g., of the platform, or accessing a centralized automation rule service 112), and may include the most used trigger components or the trigger components whose usage has exceeded a threshold value. In some cases, the recommended action components may be a curated list within a platform or the centralized automation rule service 112, and may depend on which platform a user is accessing. In some embodiments, the generative output service 116 may be trained on the usage of action components for automation rules within a platform or set of platforms, and be used to determine the recommended action components based on one or more inputs and a list of potential or candidate trigger components. In some examples, the generative output service 116 can receive (e.g., from the centralized automation rule service 112) information regarding a history of action component selections (e.g., for a particular user, group of users, particular platform, or by other groupings), and this information may be used by the generative output service 116 to provide (e.g., from the centralized automation rule service 112) an indication (e.g., suggestion or recommendation) for an action component or set of action components 1008 (e.g., as the “recommended” trigger components) as part of automation rule building and creation.

The action groups for the set of action components 1008 may be selectable via the set of tabs 1006. For example, by selecting the “spaces” selectable element, the set of action components 1008 may be pared down to display only the associated spaces actions 1014 (e.g., archive space, create space, and grant space permission), and the other available action components hidden.

Search box 1004 accepts textual inputs from a user, and in response, the rule builder 802 can filter the set of action components 1008. In some embodiments, the displayed set of action components 1008 may be pared down such that only action components that satisfy the search are displayed (and other, non-responsive action components are hidden). In other embodiments, a drop-down or pop-up may be displayed that includes selectable trigger components that satisfy the search.

In one or more embodiments, actions of the set of action components 1008 include one or more of page archiving, page ownership changing, page status changing, page copying, page deletion, page moving, new page publishing, page restriction, blog deletion, comment addition, label addition, label removing, watcher management, space permission adding, space archiving, or a combination of these. In some embodiments, these actions are for a documentation platform.

In one or more embodiments, actions of the set of action components 1008 include one or more of email sending, application message sending, text message sending, web request sending, variable creation, action logging, or a combination of these. In some embodiments, these actions are for an issue tracking platform.

FIG. 11 depicts an example frontend interface 1100 that supports automation rule creation for collaboration platforms, in accordance with aspects described herein. Frontend interface 1100 may be an example of frontend interface 1000 following selection by a user of the button for compatible actions 1102. Following such selection, the frontend interface 1100 then displays a set of compatible action components 1104 from the set of action components (e.g., as illustrated with reference to frontend interface 1000). Incompatible action components (e.g., those action components of the set of action components 1008 that are not in the set of compatible action components 1104) are then hidden or otherwise not displayed in the GUI of the rule builder 802. In other embodiments, the action components of the set of compatible action components 1104 are flagged or otherwise identified as compatible via an indicator associated with the action component. In some embodiments, action components of the set of action components 1008 that are not in the set of compatible action components 1104 are flagged or otherwise identified. Compatible and incompatible action components can similarly each be flagged or otherwise identified as compatible or incompatible, respectively.

In one or more embodiments, the recommended action components of the compatible set of action components may be based on a usage history for the user, such as the quantity of uses for the action component exceeding a threshold value or the user's most used trigger components (e.g., ten most used action components). In other embodiments, the recommended actions are based on the quantity of uses by a group of users (e.g., of the platform, or accessing a centralized automation rule service 112), and may include the most used action components or the action components whose usage has exceeded a threshold value. In some cases, the recommended action components may be a curated list within a platform or the centralized automation rule service 112, and may depend on which platform a user is accessing. In some embodiments, the generative output service 116 may be trained on the usage of action components for automation rules within a platform or set of platforms, and be used to determine the recommended action components based on one or more inputs and a list of potential or candidate trigger components.

In some examples, the generative output service 116 can receive (e.g., from the centralized automation rule service 112) information regarding a history of action component selections (e.g., for a particular user, group of users, particular platform, or by other groupings), and this information may be used by the generative output service 116 to provide (e.g., from the centralized automation rule service 112) an indication (e.g., suggestion or recommendation) for an action component or set of action components 1104 (e.g., as the “recommended” trigger components) as part of automation rule building and creation. In some embodiments, the generative output service 116 may be provided with a set of automation rule components, including information about each automation rule component, such as one or more of a context and input requirement for each automation rule component. The generative output service 116 can then use the provided automation rule components (e.g., including action components) and information to determine compatible action components 1104 associated with a state of the automation rule flow being created by a user, such as already-selected automation rule components (e.g., trigger component 910) and an ordering of the automation rule components in the rule builder 802.

The ordering of the set of compatible action components 1104 and/or the content of the set of compatible action components 1104 may vary from user to user, user role to user role, and embodiment to embodiment. For example, when interacting with a documentation system, a user having a role of “developer” may be presented with prompts associated with tasks related to an issue tracking system and/or a code repository system.

As an example, for the frontend interface 1000, the category of spaces actions 1014 includes archive space, create space, and grant space permission. However, in the set of compatible action components 1104, the category of spaces actions 1106 includes create space, but not archive space and not grant space permission because archive space and grant space permission are incompatible with the trigger component 910.

In one or more embodiments, compatible action components 1104 may be those whose addition to the automation rule at a particular position in the automation rule chain is compatible with the current automation rule chain. That is, the action component to be added is compatible with the trigger component and any action components before the position. In one or more embodiments, a compatible action component is an action component whose entity context requirements can be satisfied at a position. An action component that cannot satisfy the entity context requirements (e.g., regardless of other components that follow in the automation rule chain) is incompatible. Examples of contexts for system 100 (e.g., one or more platforms of system 100, such as a document management platform) include a database query language context, a rule initiator context, a trigger space context, a dynamic space context, an issue context, or a task context.

By way of examples, a database query language context may be updated and consumed by components that are specific to content, such as pages or blogs, and updated and consumed by components that are more type-agnostic, such as a branch or condition (e.g., a branch or condition for the database query language). The database query language context may support an object that is database query language searchable. A rule initiator context is updated by triggers that are associated with events for a document management platform, and can be set to the person who initiated the event. The rule initiator context may be consumed by a user condition. A trigger context is updated by triggers when the event can be associated with a particular space (e.g., a space of a document management platform). If there is no event with an associated space (e.g., document management platform space), the trigger context can still be set if the rule takes place in space-level automation. A dynamic space context may be updated by any component that outputs a dynamic text reference (which may also be referred to as a “smart value”) for a space (e.g., “{{space}}”). An issue context may be used for integrations to an issue tracking platform. A task context may be used for action that operate on tasks (e.g., an update task status action component).

In some cases, an action component may be required to update the same context. For example, a move page action component may need to define an update to database query language context and also require the database query language context. In some embodiments, all actions may declare their outputs for consistency, which may help to facilitate the static analysis of automation rules, and in particular validating component compatibility. In one example, the following automation rules may be valid only sometimes: task created trigger component followed by move page action component (Task Created->Move page). In one example, if the task from the trigger was added to a page, then the ‘Move page’ action will execute successfully. But if the task from the trigger was added to a blogpost, then the ‘Move page’ action will fail. As such, this automation rule may be valid in some automation rules, but not others. As such, following the task created trigger component, the move page action component can be indicated as compatible and available for selection, even though the automation rule may not successfully validate. In some embodiments, incompatible components are those components that will be definitely incompatible (e.g., definitely result in an invalid automation rule). As an example, the following automation rules would all pass rule validation: Task created->Move page; Task created->Delete blog; Task created->Move page->Add label; and Task created->Move page->Restrict page. However, the following rule would not pass validation: Task created->Move page->Delete blogpost. By the time the ‘Delete blogpost’ action component executes, the database query language context must contain a page, because otherwise the ‘Move page’ action would not have finished executing. But in order to distinguish this case from the others during static analysis (e.g., for rule validation), the ‘Move page’ action component must be defined to set the database query language context to a page specifically. As such, even if the type is unknown before the ‘Move page’ action, the type after the ‘Move page’ action is known.

In one or more embodiments, a context graph may be defined and used to validate an automation rule and/or determine which components (e.g., action components) are compatible to add to an automation rule. An example of using a context graph follows.

In one example, call the set of all entity contexts for a system or platform C. In some embodiments, the set C is different for each system or platform. For example, a document management platform may have some entity contexts that an issue tracking platform does not have, and vice versa. However, some entity contexts may be shared between systems or platforms. Define an “entity context state” s to be a set of tuples <c, possible Types> where c is an entity context and possibleTypes is a subset of c.supportedTypes. Every s must have one element <c, possibleTypes> for every c in C (in other words, no entity contexts can be left out of a state). Each s represents the state of all the entity contexts at a particular point in a rule. Each member reveals what types may be present in the respective entity context. An entity context may only contain one type at a time, but that type may be undetermined at rule creation time (e.g., as a result a context can be mapped to multiple types).

Define a “context node” n to be a tuple <satisfied, update, children> where: satisfied is a function that accepts an entity context state and returns true or false (true if the entity context state can possibly satisfy the requirements of n; and false if the entity context state cannot satisfy the requirements of n); update is a function that accepts an entity context state and returns another (possibly identical) entity context state; and children is a (possibly empty) list of lists of context nodes. In one or more embodiments, satisfied only returns false if the state cannot satisfy the requirements. Each context node corresponds to a component in the rule builder. Define a “context graph” to be a list of context nodes, representing some chunk of an automation rule.

The following pseudocode is an example that defines a function to return all unsatisfied nodes from a context graph:

```
func find_invalid(graph, prior_state=null):
  var invalid = new Set( )
  var state
  if prior_state != null:
  state = copy_of(prior_state)
else:
  state = new Set( )
for node in graph:
  # check if node is invalid given current state
  if not node.satisfied(state):
    invalid.add(node)
  # do not mutate the current state right away
  var local_state = node.update(state)
  # recursively process children
  for child_graph in node.children:
    invalid.add(find_invalid(child_graph, local_state))
  # only mutate current state if do not have children
  if node.children.length == 0:
    state = local_state
```

In one or more embodiments, context persists only within the scope of a branch of an automation rule. In some embodiments, the validation traverses to all edges of a branch.

FIG. 12 depicts an example frontend interface 1200 that supports automation rule creation for collaboration platforms, in accordance with aspects described herein. Frontend interface 1200 may be an example of frontend interface 1000 and/or frontend interface 1100 following selection by a user of one of action components from the set of compatible action components 1104 (or the action components 1008), and in particular after the action components of publish new page 1210, add label 1212, restrict page 1214, and delete page 1216 were selected and added to the automation rule chain shown for example frontend interface 1200.

Following the selection and addition of the action components shown with reference to frontend interface 1200, the quantity of compatible action components may be further limited. For example, in addition to being compatible with the trigger component 910, each action component may also need to be compatible with each other action component before the current action component under consideration. According to the illustrated example, the action component 1218 needs to be compatible with the publish new page 1210, add label 1212, restrict page 1214, and delete page 1216 action components in addition to the trigger component 910 that is scheduled. As such, when a user selects the compatible actions button 1202 of the set of tabs 1006, the action components 1204 that are displayed are those that are compatible with the whole, current automation rule. In one or more examples, the action components 1204 that are compatible include those in groups of recommended, pages and blogs, and spaces. The recommended action components include a transition an issue in Jira, edit an issue in Jira, create issue in Jira, publish a new page, or send an email. The pages and blogs group includes only a single action component: publish new page. The spaces actions 1206 include archiving a space, creating a space, or granting space permissions. By contrast, the pages and blogs group 1016 illustrated with reference to the frontend interface 1000 contained thirteen action components.

In one or more embodiments, a smaller quantity of action components may be available as compatible later in the process of creating an automation rule. However, in some embodiments, a greater quantity of action components may be available as compatible later in the process of creating the automation rule. For example, following selection of the trigger component 910 that is scheduled, for example as described with reference to the frontend interface 1100, the compatible actions 1102 may include only a single action component for spaces actions 1106: the create space action component. However, following the addition of one or more action components, three different action components for spaces actions 1014 may be available or indicated as compatible (e.g., archive space, create space, and grant space permission action components).

FIG. 13 depicts an example frontend interface 1300 that supports automation rule creation for collaboration platforms, in accordance with aspects described herein. Frontend interface 1300 includes a rule builder 802 that displays a trigger component 1302 for scheduling, and an action component 1304 for page archiving. However, in this instance, the action component 1304 for page archiving may be incompatible with the trigger component 1302 for scheduling. The system (e.g., system 100, including one or more of the first platform backend 108 or the second platform backend 110) with which a user (e.g., via client device 104 or client device 106) is interacting may identify that one or more compatibility criteria are not satisfied. In response, the system may render in the GUI of the rule builder 802, a narrative 1306 including content related to a potential incompatibility between one or more adjacent components. In some embodiments, the narrative 1306 may be rendered together with a narrative 1308 that includes a description for the action component 1304 for which the narrative 1306 is generated.

FIG. 14 depicts an example frontend interface 1400 that supports automation rule creation for collaboration platforms, in accordance with aspects described herein. Frontend interface 1400 includes a rule builder 802 that displays a trigger component 1402 for scheduling, an action component 1404 for adding a comment to a page, and an action component 1406 for archiving a page.

In this example, the action component 1404 and the action component 1406 may be incompatible with the trigger component 1402 for scheduling. The system with which a user is interacting may identify that one or more compatibility criteria are not satisfied. In response, the system may render in the GUI of the rule builder 802, a narrative 1412 including content related to a potential incompatibility between one or more adjacent components. In one or more embodiments, the narrative 1412 may describe the error and/or suggest one or more ways in which the error can be resolved. The rule builder 802 may determine compatibility when an action component is added to the automation rule that is being created, such that the narrative 1412 may be present when the incompatible action component is added to the rule, or updated when further incompatible actions are added, removed, or otherwise modified in the case of multiple incompatible automation rule components. In some embodiments, one or more indicators 1408 (e.g., identifiers, flags, or other graphical elements), such as the illustrated exclamation points within a diamond, may be rendered on the graphical elements for the action component 1404 and action component 1406 to provide a visual cue to the user of the source of the error.

In the example of frontend interface 1400, the action component 1404 has been configured to add a comment that includes one or more dynamic text reference 1410. Upon running the automation rule, the action component 1404 will add a comment to a page in the form “Hey {{page.author}} we've archived this page . . . ” As part of running of the automation rule, the dynamic text reference “{{page.author}}” will be replaced with the page author for the associated page, where the page author may be a part of the metadata or other information associated with the page to which the comment is being added. In some embodiments, the dynamic text reference 1410 may be referred to as a “smart value.”

FIGS. 15A-15D depict examples of a first portion 1501 (FIG. 15A), a second portion 1502 (FIG. 15B), a third portion 1503 (FIG. 15C), and a fourth portion 1504 (FIG. 15D) of a frontend interface that supports automation rule creation for collaboration platforms, in accordance with aspects described herein.

The first portion 1501 of the frontend interface illustrates at least a part of a display rendered for a GUI for an automation rule builder, as further discussed herein, that displays portions (e.g., a draft portion) of an automation rule that is being created. The automation rule includes a trigger component 1510, a condition component 1512, and an action component 1514. A graphical element 1516 (e.g., an “add component” button) can be selected to provide an interface for a user to select additional automation rule components (e.g., actions, conditions, branches, and so on).

The second portion 1502 of the frontend interface illustrates at least a part of a display rendered for a GUI for the automation rule builder. The second portion 1502 includes an interface for modification of the trigger component 1510, including input fields and selection interfaces (e.g., dropdowns) for a frequency to run the rule, a day of the week to run the rule, and a time to run the rule (e.g., including a selection for the time zone). Narrative descriptions of the rule, and an indication of a date and time at which the rule will run may also be included.

The third portion 1503 of the frontend interface illustrates at least a part of a display rendered for a GUI for the automation rule builder. In the example of the third portion 1503, a dynamic text reference (e.g., a “smart value”) and/or regular expression may be compared with another dynamic text reference and/or regular expression. The third portion 1503 includes an interface for modification of the condition component 1512, including a narrative portion 1530 that describes the condition component 1512. The third portion 1503 includes inputs and interfaces for modification of the condition component 1512, including input fields and selection interfaces (e.g., dropdowns). In this example, the third portion 1503 includes a first input field 1534 for a first value and a second input field 1538 for a second value. A third input field 1536 specifies the condition to compare the first value with the second value. In this examples, a dynamic text reference, such as {{page.title.toLowerCase( )}} (the page title in lowercase) is compared with the regular expression “meeting notes.” If the page title includes the regular expression “meeting notes,” then the condition returns true. Because the condition is true, the automation rule proceeds to the next automation rule component, which is the action component 1514.

The fourth portion 1504 of the frontend interface illustrates at least a part of a display rendered for a GUI for the automation rule builder. In the example of the fourth portion 1504, dynamic text references (e.g., “smart values”) and/or regular expressions may be used to populate portions of a template, in this case for an email to be sent according to the automation rule. The fourth portion 1504 includes interfaces for modification of the action component 1514, including a narrative portion 1540 that describes the action component 1514 (“Send an email with an AI-generated summary and action items when a meeting notes page is published.”).

The fourth portion 1504 also includes inputs and interfaces 1542 for modification of the action component 1514, including input fields and selection interfaces (e.g., dropdowns). In this example, the fourth portion 1504 includes a first input field 1544 for email addresses, which may also be populated via a dropdown selection. In some cases, the email addresses may be auto populated as a user types (e.g., all emails within a domain or other grouping that start with “st” are displayed in a selectable list when a user inputs the letters “st” into the first input field 1544).

A second field 1546 and a third field 1548 may include regular expressions, one or more dynamic text references, or a combination of regular expressions and dynamic text references. For example, as shown for the fourth portion 1504, the second field 1546 recites “Summary and action items for page ‘{{page.title}}’” such that the title of the page acted on by the action component 1514 is inserted in the subject line of the email to replace {{page.title}}.

The third field 1548 includes a first dynamic text reference 1550 and a second dynamic text reference 1552. The first dynamic text reference 1550 may be a request for generative output service (e.g., generative output service 116) to insert a summary of a page into a text description in the third field 1548. In some examples, when the automation rule containing the dynamic text reference is run, the centralized automation rule service 112 may provide a request to the prompt management service 114 that prepares a prompt for the generative output engine that is based on the dynamic text reference, then provides the prompt to the generative output service 116, which prepares a response. The response is provided back to the prompt management service 114 and centralized automation rule service 112, then the platform backend from which the automation rule is being run. For example, for the first dynamic text reference 1550, {{page.aiSummary}}, a prompt may be generated that includes text from the page (or at least a portion of the page) and information regarding a format, parameters, example outputs, and so on for generating the summary. For the second dynamic text reference 1552, {{page.aiActionItems}}, a prompt may be generated that includes text from the page (or at least a portion of the page) and information regarding a format for the action items, parameters, example outputs, and so on for generating a set or list of action items. Responses are then provided by the generative output service 116, and the responses are inserted in the email body to replace {{page.aiSummary}} and {{page.aiActionItems}} in the third field 1548 (e.g., the email body).

FIG. 16 depicts an example of a portion 1600 of a frontend interface that supports automation rule creation for collaboration platforms, in accordance with aspects described herein. In particular, portion 1600 illustrates a UI to edit (customize, modify, create) an action component 1602 to send an email including specified criteria as part of an automation rule.

In this example, the portion 1600 includes a first input field 1604 for email addresses, which may be populated via a text entry, or be populated via a dropdown selection. In some cases, the email addresses may be auto populated as a user types.

A second input field 1606 and a third input field 1608 may include regular expressions, one or more dynamic text references, or a combination of regular expressions and dynamic text references. For example, the second input field 1606 recites “Issue {{issue.key}} was just updated!” such that the issue key associated with an issue (e.g., in an issue tracking system) is inserted in the subject line of the email to replace {{issue.key}}.

The second input field 1606 and/or the third input field 1608 may also include one or more dynamic text references that may be auto populated as a user types. For example, if a user types “{{” to begin a dynamic text reference, then the system may identify and render a set (e.g., as a dropdown or other listing) of dynamic text references. In some embodiments, the identified and rendered dynamic text reference may be those that the system identifies as compatible with the current action component, as well as compatible with prior action components and/or trigger components for the automation rule to which the portion 1600 applies. For example, as illustrated for the third input field 1608, for sending an email in this context (e.g., triggered based on a trigger component in an issue tracking system), there may be three dynamic text references that are compatible: a first dynamic text reference 1610 that returns an issue reporter's full name (e.g., {{reporter.displayName}}), a second dynamic text reference 1612 that returns the full name of the user that triggered the rule (e.g., {{initiator.displayName}}), and a third dynamic text reference 1614 that returns an issue's status (e.g., {{issue.status.name}}). In some embodiments, the dynamic text references may be provided alphabetically. In other embodiments, the dynamic text references may be provided in order of a frequency of use by a user or a group of users, or for a particular platform.

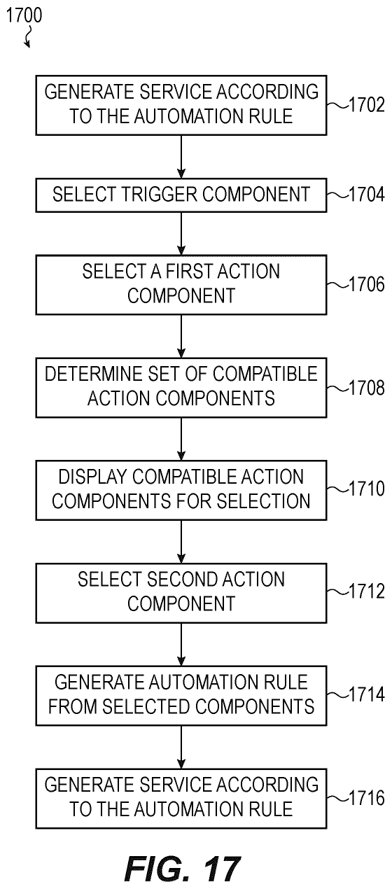

FIG. 17 shows an example method 1700 of automation rule creation, for example in collaboration platforms, according to one or more aspects described herein. In one or more embodiments, method 1700 supports one or more aspects of automation rule creation, as further described herein, for example with reference to any one or more of FIGS. 1A-16. The method 1700 may be performed using a processor and/or memory, or other components of the content collaboration system.

At 1702, the method 1700 includes generating a GUI with an automation rule input field. In some embodiments, the method 1700 includes causing generation of a GUI of the collaboration system, the GUI including an input field for receiving user input. In some embodiments, the trigger component is associated with a change to a first object of the collaboration system.

At 1704, the method 1700 includes selecting a trigger component. In some embodiments, the method 1700 includes receiving a first input of the GUI indicating a selection of the trigger component for an automation rule. In one or more embodiments, the method 1700 includes causing generation of a first one or more graphical elements representing the selected trigger component in the graphical user interface. In some embodiments, the generation is in response to receiving an input of the graphical user interface indicating the selection of the trigger component.

At 1706, the method 1700 includes selecting a first action component. In some embodiments, the method 1700 includes receiving a first input of the GUI indicating a selection of the first action component for an automation rule. In some embodiments, the method 1700 includes causing generation of a first one or more graphical elements representing the selected first action component in the graphical user interface. In some embodiments, the generation is in response to receiving an input of the graphical user interface indicating the selection of the first action component.

At 1708, the method 1700 includes determining a set of compatible action components. In some embodiments, the method 1700 includes determining a first set of compatible action components for the selected first action component based at least in part on, for each action of the first set of compatible action components, an ordering of the action within the automation rule and a compatibility between the action and the selected first action component. In some embodiments, the determining is in response to receiving an input of the graphical user interface indicating the selection of the triggering components, the first action component, or both.

At 1710, the method 1700 includes displaying compatible action components for selection. In one or more embodiments, the method 1700 further includes causing generation of a first set of graphical elements in the graphical user interface, each graphical element of the first set of graphical elements corresponding to a respective action of the first set of compatible action components. In some embodiments, the generation is in response to receiving an input of the graphical user interface indicating the selection of the triggering components, the first action component, or both.

At 1712, the method 1700 includes selecting a second action component. In one or more embodiments, the method 1700 includes selecting a compatible action component (the second action component) from the first set of compatible action components. In some embodiments, the method 1700 further includes causing generation of a second graphical element representing the selected compatible action component in the graphical user interface. In one or more embodiments, the generation is in response to receiving a second input of the GUI indicating the selection of a compatible action component from the first set of compatible action components.

At 1714, the method 1700 includes generating an automation rule based on the selected components. In one or more embodiments, the method 1700 includes saving an automation rule that includes at least the selected trigger component, the selected compatible action component, and an object identifier. In some embodiments, the saving is in response to receiving a third input of the graphical user interface indicating for the collaboration system to save the automation rule.

At 1716, the method 1700 includes generating a service according to the automation rule. In one or more embodiments, the method 1700 includes generating a service on the collaboration system that performs an operation in response to an event satisfying the selected trigger component. In some embodiments, the operation corresponds to the action component. In some embodiments, the operation is further performed on a set of objects selected using the object identifier.

In one or more embodiments, the method 1700 further includes enabling the service. In some embodiments, the enabling may be in response to each component of the automation rule satisfying compatibility criteria with each respective adjacent component of the automation rule. In one or more embodiments, the method 1700 further includes causing display of a narrative including content related to a potential incompatibility between one or more adjacent components. In some embodiments, the displaying may be in response to each component of the automation rule not satisfying the compatibility criteria with each respective adjacent component of the automation rule.

In one or more embodiments, the method 1700 further includes determining, for each action component of the first set of compatible action components, whether a user of the collaboration system has permission to perform an action associated with the action component. In some embodiments, the determining includes determining whether the user has permission to access a platform of the collaboration system that is associated with the action. In some embodiments, the method further includes causing display of the action component in response to determining that the user has permission to access the platform.

In one or more embodiments, the method 1700 further includes determining whether a user of the collaboration system has permission to access a content item of the collaboration system that is referenced by the action. In some embodiments, the method 1700 further includes causing display of the action component in response to determining that the user has permission to access the content item.

In one or more embodiments, the method 1700 further includes performing a validation check on the automation rule and, in response to identifying that the validation check has failed for the automation rule, causing generation of a graphical element flagging the automation rule as invalid. In some embodiments, the validation check includes verifying that each action component of the automation rule has all required inputs. In some embodiments, the third graphical element flagging the automation rule as invalid is caused to be generated in proximity to an invalid action. In some embodiments, the method 1700 further includes, in response to identifying that the validation check has failed for the automation rule, causing generation of one or more natural language strings that suggest a fix for the automation rule.

In one or more embodiments, the method 1700 further includes causing generation of an input field for receiving a user input to define one or more inputs to the compatible action component. In some embodiments, the second graphical element is generated at least in part in response to receiving the user input for the compatible action component. In some embodiments, the generation is in response to receiving the second input of the GUI indicating the selection of the compatible action component from the first set of compatible action components.

In one or more embodiments, the method 1700 further includes determining a set of one or more potential values consistent with the one or more characters entered in the input field, and causing generation of a selectable list based on the set of one or more potential values. In some embodiments, the valid input to the input field comprises a selection of a value of the selectable list. In some embodiments, the determining and generation are in response to one or more characters entered in the input field for receiving the user input for the compatible action component.

In one or more embodiments, the method 1700 further includes determining a set of one or more potential values consistent with the one or more characters entered in the input field, and causing generation of a suggestion of at least one potential value of the set of one or more potential values within the input field for the user input. In some embodiments, the valid input to the input field comprises a selection of the suggestion of the at least one potential value. In some embodiments, the determining and generation are in response to one or more characters entered in the input field for receiving the user input for the compatible action component.

In one or more embodiments, the method 1700 further includes transmitting a call to a generative output engine that includes a prompt that is based at least in part on a content item of the collaboration system, and obtaining, from the generative output engine and in response to the prompt, a generative output for inclusion in the input field. In some embodiments, the valid input to the input field for the compatible action component includes a reference configured to cause the collaboration system to perform the transmitting and obtaining.

In one or more embodiments, causing generation of the first set of graphical elements includes arranging the first set of graphical elements in the graphical user interface according to an order that is based at least in part on a ranking of actions of the first set of compatible action components.

In one or more embodiments, the first object is of a first platform of the collaboration system, and the first action component or at least one of the first set of compatible action components are of a second platform of the collaboration system.

The method 1700 may be variously embodied, extended, or adapted, as described in the following paragraphs and elsewhere in this description.

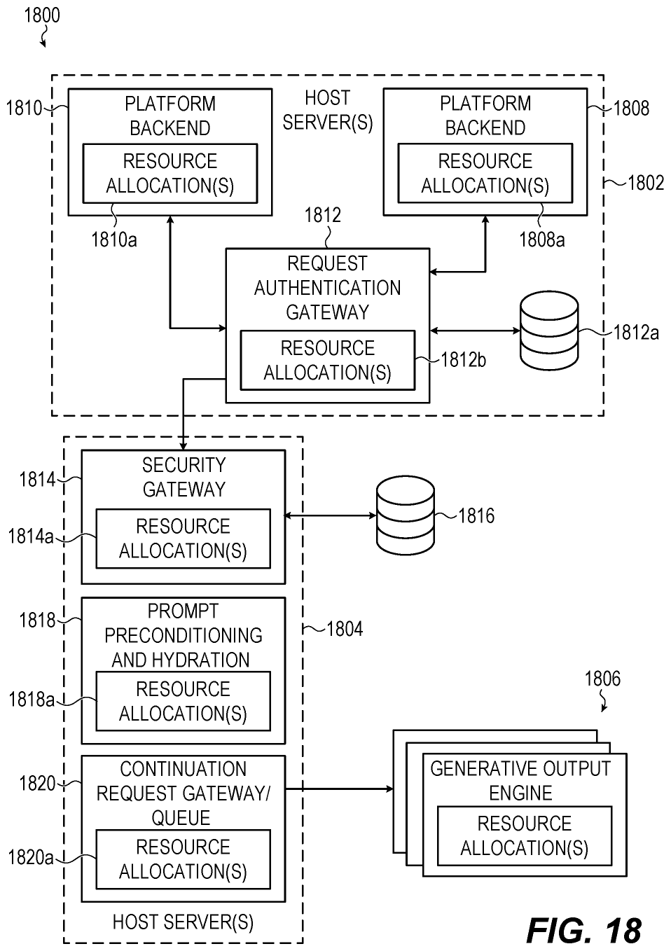

FIG. 18 depicts a system diagram and network/communication architectures that may support a system as described herein. The system 1800 includes a first set of host servers 1802 associated with one or more software platform backends. These software platform backends can be communicably coupled to a second set of host servers 1804 purpose configured to process requests and responses to and from one or more generative output engines 1806.

Specifically, the first set of host servers 1802 (which, as described above can include processors, memory, storage, network communications, and any other suitable physical hardware cooperating to instantiate software) can allocate certain resources to instantiate a first and second platform backend, such as a first platform backend 1808 and a second platform backend 1810. Each of these respective backends can be instantiated by cooperation of processing and memory resources associated with each respective backend. As illustrated, such dedicated resources are identified as the resource allocations 1808a and the resource allocations 1810a.

Each of these platform backends can be communicably coupled to an authentication gateway 1812 configured to verify, by querying a permissions table, directory service, or other authentication system (represented by the database 1812a) whether a particular request for generative output from a particular user is authorized. Specifically, the second platform backend 1810 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1812 can deny the request for insufficient permissions. This example is merely one and is not intended to be limiting; many possible authorization and authentication operations can be performed by the authentication gateway 1812. The authentication gateway 1812 may be supported by physical hardware resources, such as a processor and memory, represented by the resource allocations 1812b.

Once the authentication gateway 1812 determines that a request from a user of either platform is authorized to access data or resources implicated to service that request, the request may be passed to a security gateway 1814, which may be a software instance supported by physical hardware identified in FIG. 18 as the resource allocations 1814a. The security gateway 1814 may be configured to determine whether the request itself conforms to one or more policies or rules (data and/or executable representations of which may be stored in a database 1816) established by the organization. For example, the organization may prohibit executing prompts for offensive content, value-incompatible content, personally identifying information, health information, trade secret information, unreleased product information, secret project information, and the like. In other cases, a request may be denied by the security gateway 1814 if the prompt requests beyond a threshold quantity of data.

Once a particular user-initiated prompt has been sufficiently authorized and cleared against organization-specific generative output rules, the request/prompt can be passed to a preconditioning and hydration service 1818 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 1818 can be a software instance supported by physical hardware represented by the resource allocations 1818a. In some implementations, the hydration service 1818 may also be used to rehydrate personally identifiable information (PII) or other potentially sensitive data that has been extracted from a request or data exchange in the system.

One a prompt has been modified, replaced, or hydrated by the preconditioning and hydration service 1818, it may be passed to an output gateway 1820 (also referred to as a continuation gateway or an output queue). The output gateway 1820 may be responsible for enqueuing and/or ordering different requests from different users or different software platforms based on priority, time order, or other metrics. The output gateway 1820 can also serve to meter requests to the generative output engines 1806.

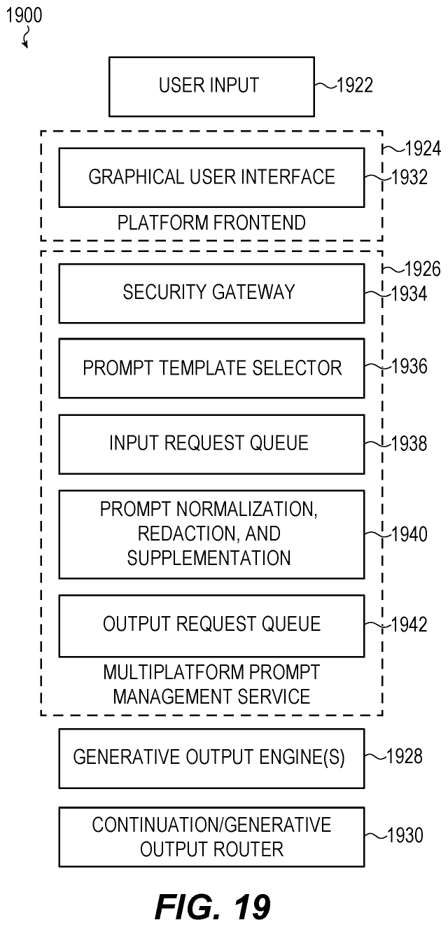

FIG. 19 depicts a functional system diagram of the system 1800. In particular, the system 1900 is configured to operate as a multiplatform prompt management service supporting and ordering requests from multiple users across multiple platforms. In particular, a user input 1922 may be received at a platform frontend 1924. The platform frontend 1924 passes the input to a prompt management service 1926 that formalizes a prompt suitable for input to a generative output engine 1928, which in turn can provide its output to an output router 1960 that may direct generative output to a suitable destination. For example, the output router 1960 may execute API requests generated by the generative output engine 1928, may submit text responses back to the platform frontend 1924, may wrap a text output of the generative output engine 1928 in an API request to update a backend of the platform associated with the platform frontend 1924, or may perform other operations.

Specifically, the user input 1922 (which may be an engagement with a button, typed text input, spoken input, chat box input, and the like) can be provided to a graphical user interface 1932 of the platform frontend 1924. The graphical user interface 1932 can be communicably coupled to a security gateway 1934 of the prompt management service 1926 that may be configured to determine whether the user input 1922 is authorized to execute and/or complies with organization-specific rules.

The security gateway 1934 may provide output to a prompt selector 1936 which can be configured to select a prompt template from a database of preconfigured prompts, templatized prompts, or engineered templatized prompts. Once the raw user input is transformed into a string prompt, the prompt may be provided as input to a request queue 1938 that orders different user requests for input from the generative output engine 1928. Output of the request queue 1938 can be provided as input to a prompt hydrator 1940 configured to populate template fields, add context identifiers, supplement the prompt, and perform other normalization operations described herein. In other cases, the prompt hydrator 1940 can be configured to segment a single prompt into multiple discrete requests, which may be interdependent or may be independent.

Thereafter, the modified prompt(s) can be provided as input to an output queue at 1942 that may serve to meter inputs provided to the generative output engine 1928.

These foregoing embodiments depicted in FIG. 18-19 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

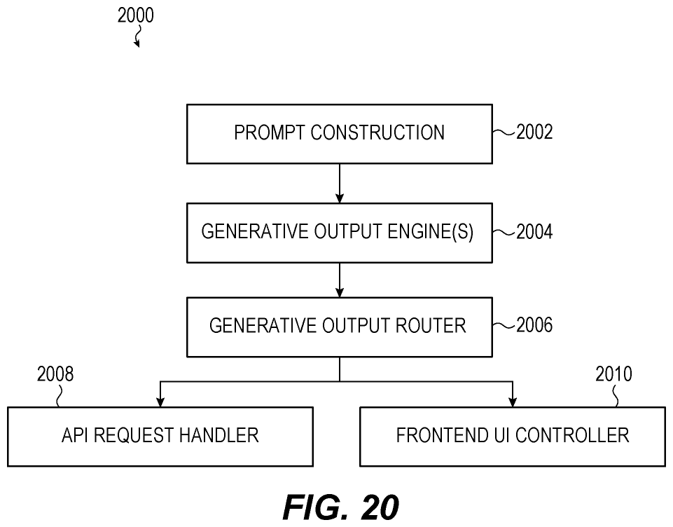

Although many constructions are possible, FIG. 20 depicts a simplified system diagram and data processing pipeline as described herein. The system 2000 receives user input, and constructs a prompt therefrom at operation 2002. After constructing a suitable prompt, populating template fields, and selecting appropriate instructions and examples for an LLM to continue, the modified constructed prompt is provided as input to a generative output engine 2004. A continuation from the generative output engine 2004 is provided as input to a router 2006 configured to classify the output of the generative output engine 2004 as being directed to one or more destinations. For example, the router 2006 may determine that a particular generative output is an API request that should be executed against a particular API (e.g., an API of a system or platform as described herein). In this example, the router 2006 may direct the output to an API request handler 2008. In another example, the router 2006 may determine that the generative output may be suitably directed to a graphical user interface/frontend. For example, a generative output may include suggestions to be shown to a user below a user's partial input, such as shown in FIGS. 8-16.

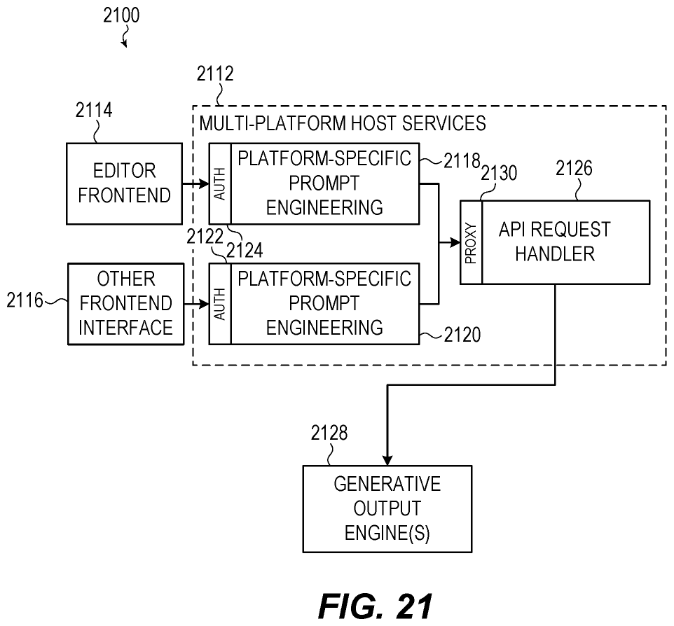

Another example architecture is shown in FIG. 21, illustrating a system providing prompt management, and in particular multiplatform prompt management as a service. The system 2100 is instantiated over cloud resources, which may be provisioned from a pool of resources in one or more locations (e.g., datacenters). In the illustrated embodiment, the provisioned resources are identified as the multi-platform host services 2112.

The multi-platform host services 2112 can receive input from one or more users in a variety of ways. For example, some users may provide input via an editor region 2114 of a frontend, such as described above. Other users may provide input by engaging with other user interface elements 2116 unrelated to common or shared features across multiple platforms. Specifically, the second user may provide input to the multi-platform host services 2112 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 2112 can include multiple software instances or microservices each configured to receive user inputs and/or proposed prompts and configured to provide, as output, an engineered prompt. In many cases, these instances—shown in the figure as the platform-specific prompt engineering services 2118, 2120—can be configured to wrap proposed prompts within engineered prompts retrieved from a database such as described above.

In many cases, the platform-specific prompt engineering services 2118, 2120 can be each configured to authenticate requests received from various sources. In other cases, requests from editor regions or other user interface elements of particular frontends can be first received by one or more authenticator instances, such as the authentication instances 2122, 2124. In other cases, a single centralized authentication service can provide authentication as a service to each request before it is forwarded to the platform-specific prompt engineering services 2118, 2120.

Once a prompt has been engineered/supplemented by one of the platform-specific prompt engineering services 2118, 2120, it may be passed to a request queue/API request handler 2126 configured to generate an API request directed to a generative output engine 2128 including appropriate API tokens and the engineered prompt as a portion of the body of the API request. In some cases, a service proxy 2130 can interpose the platform-specific prompt engineering services 2118, 2120 and the request queue/API request handler 2126, so as to further modify or validate prompts prior to wrapping those prompts in an API call to the generative output engine 2128 by the request queue/API request handler 2126 although this is not required of all embodiments.

These foregoing embodiments depicted in FIGS. 20-21 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

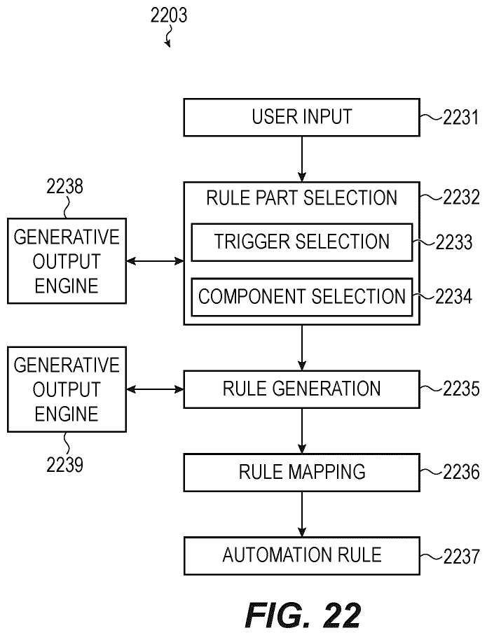

FIG. 22 depicts an example process flow 2203 that supports automation rule creation, modification, and/or customization for collaboration platforms, in accordance with aspects described herein. More particularly, the example process flow 2203 describes how a generative output service may be used to generate rule specifications, including rule specifications that are based at least in part on a predetermined automation rule template and a natural language user input (as described, for example, with respect to FIG. 4E. Process flow 2203 includes operations that may be performed by system 100, which may also be referred to as a content collaboration system herein.

At 2231, a user input is received. In some cases, the user input includes a natural language input from a user. In some cases, as described herein (e.g., with respect to FIG. 4E), the user input may include a natural language input portion (e.g., received via natural language input field 422 in FIG. 4E), in addition to information about one or more prepopulated automation components (e.g., automation components of an automation rule template that is suggested in an automation rule suggestion interface).

At 2232, rule parts are selected. In one or more embodiments, system 100 performs trigger selection 2233 (e.g., to select a trigger component of an automation rule) and component selection 2234 (e.g., to select other components of an automation rule, such as condition components, action components, etc.). In some embodiments, rule part selection is performed by a combination of components of system 100, including one or more of centralized automation rule service 112, prompt management service 114, or generative output service 116. In one or more embodiments, generative output service 116 may be, be referred to as, or include a generative output engine. In some embodiments, generative output engine 2238 may be internal to system 100. In some embodiments, generative output engine 2238 may be external to system 100. For example, generative output service 116 may coordinate or otherwise operate to facilitate communications and services with the generative output engine 2238, which may be a service provided by a third party, for example.

In one or more embodiments, trigger selection 2233 includes generating a trigger-selection prompt, providing the trigger-selection prompt to a generative output engine using a first API interface call, and obtaining a first generative response from the generative output engine response to the first API interface call. At 2238, the generative output engine 2238 may take as an input the trigger-selection prompt, and provide as an output the first generative response. In some embodiments, the trigger-selection prompt includes at least a portion of a natural language string, a set of example automation trigger schemas, and a set of example input-output natural language to trigger pairs.

In one or more embodiments, component selection 2234 includes generating a component-selection prompt, providing the component-selection prompt to a generative output engine using a second API interface call, and obtaining a second generative response from the generative output engine response to the second API interface call. At 2238, the generative output engine 2238 may take as an input the component-selection prompt, and provide as an output the second generative response. In some embodiments, the component-selection prompt includes least a portion of the natural language string, a set of example automation components or rule clauses, and a set of example input-output natural language to automation component or rule clause pairs. The component(s) for component selection 2234 may be one or more of the components discussed herein, for example one or more condition components, action components, or the like. In some embodiments, the automation component or rule clause pairs may include branches, and the set of examples of input-output natural language to automation component or rule clause pairs may include examples mapping natural language branching terms to branch terms used by one or more platforms of the system 100.

An example of at least a portion of a prompt provided as input, including exemplary triggers, conditions, actions, and an automation trigger schema may be:

```
{
“product”: “Documentation Platform”,
“generative_output_service_config”: {
  “user intent”: “You are a helpful assistant.
  Use the following knowledge to create rules.
  ## Issue Fields
  An issue contains the following fields:
```

| | |
|---|---|
| - | Status: one of ‘todo’, ‘in progress’, ‘done’. |
| - | Priority: one of ‘high’, medium’, ‘low’. |
| - | Assignee: the Id of the assigned user. |
| - | Summary: the summary of the issue. |
| - | Description: the description of the issue. |

```
  ## Automation Rule
  An automation rule contains ‘name’, ‘trigger’, and one or multiple ‘components’.
  ### Triggers
  #### Issue Created
  Rule is run when an issue is created. This trigger needs no configuration.
```

| | |
|---|---|
| - | Type: ‘issue_created’ |

```
  #### Issue Updated
  Rule is run when an issue is updated. This trigger needs no configuration.
```

| | |
|---|---|
| - | Type: ‘issue_updated’ |

```
  #### Issue Assigned
  Rule is run when an issue is assigned to a user. This trigger needs no configuration.
```

| | |
|---|---|
| - | Type: ‘issue_assigned’ |

```
  ### Conditions
  #### Issue Field Condition
  Checks whether an issue's field meets certain criteria. It contains fields.
```

| | |
|---|---|
| - | Type: ‘issue_field_condition’ |
| - | Field: the name of the issue field |
| - | Condition: one of ‘equals’, ‘does not equal’, ‘is one of’, ‘is not |
| | one of’ |
| - | Value: the value of the issue field |

```
  ### Actions
  #### Assign Issue
  Assign an issue to a user
```

| | |
|---|---|
| - | Type: ‘issue_updated’ |

```
  #### Issue Assigned
  Rule is run when an issue is assigned to a user. This trigger needs no configuration.
```

| | |
|---|---|
| - | Type: ‘issue_assigned’ |

```
  #### Send Email
  Send an email to the given email address. It contains the following fields
```

| | |
|---|---|
| - | Type: ‘send_email’ |
| - | To: the email address |
| - | Subject: the subject of the email |
| - | Content: the content of the email |

```
  ## Rule Schema
  Below is the JSON schema to create rule data. The trigger can only be one of
  ‘issue_created’, ‘issue_updated’, ‘issue_assigned’
  ’’’json
  {
    “$schema”: “http://json-schema.org/.../schema#,
    “type”: “object”,
    “required”: [“name”, “trigger”, “components”],
    “properties”: {
      “name”: {
        “type”: “string”,
        “description”: “the name of the automation rule”
      }
    “trigger”: {
      “$ref’: “#/definitions/component”,
      “description”: “It can only be a rule trigger. It can not be an action.”
    }
    “components”: {
      “type”: “array”,
      “items”: {
        $ref”: “#/definitions/component”
      },
      “description”: “the actions and conditions for the automation rule”
    }
  }
```

In some cases, the pseudo-query language translation of the input prompt may be, itself, a generative output of a generative output engine. In these examples, a first request may be submitted to a generative output engine. In response to receiving this modified prompt, the generative output engine may generate the previous example pseudo-query language query.

Rule generation 2235 includes generating a rule-selection prompt for the generative output engine 2239, providing the rule-selection prompt to the generative output engine using a third API call, and obtaining a third generative response from the generative output engine responsive to the third API call. In one or more embodiments, the rule-selection prompt includes at least a portion of the first generative response (associated with the trigger selection 2233), at least a portion of the second generative response (associated with the component selection 2234), and a set of example automation rules.

Generative output engine 2239 may be the same as, or different from, generative output engine 2238. For example, generative output engine 2238 may be or use a same third party service as generative output engine 2239. In other examples, generative output engine 2238 may be or use a different third party service then generative output engine 2239.

In one or more embodiments, the third generative response includes a textual output, which is mapped to components specific to a platform applicable for the automation rule. The textual output of the third generative response may be or be referred to as an initial automation rule. As such, rule mapping 2236 includes identifying, based on the third generative response, one or more automation rule components, for example specific to the platform or platforms (e.g., for an automation rule that operates from one or more platforms to one or more different platforms).

Following rule mapping 2236, an automation rule 2237 may be constructed. In some cases, rule mapping 2236 (and/or any other operations described in FIG. 22) includes or results in incorporating automation components that were part of a suggested automation rule specification in the automation rule. For example, automation components that were part of the automation rule template in FIG. 4E may be maintained in the automation rule 2237. In some cases, automation components from the automation template that are incompatible with components that are generated in response to the user's natural language input may be omitted. In particular, the prompt to the generative output engine may include an instruction that in the case of conflict between the existing automation components and new automation components selected as a result of the user's natural language input, preference should be given to the new automation components.

In one or more embodiments, a representation of the automation rule 2237 may be displayed at a GUI at a frontend interface (e.g., in an automation rule suggestion interface, an automation rule builder, or the like), which may be a GUI at one or both of client device 104 or client device 106. In one or more embodiments, finalizing or otherwise completing the automation rule 2237 (e.g., by saving the automation rule from the GUI) may include generating a service on the content collaboration system (e.g., system 100) that performs an operation in response to an event satisfying the one or more triggers. The operation may correspond to the one or more automation components or rule clauses, and the operation may be performed on a set of objects selected using the object identifier. In some examples, the automation rule 2237 may be a complete or final automation rule, usable by system 100.

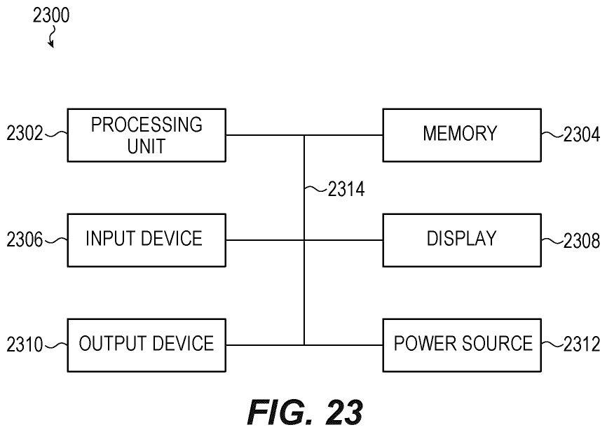

FIG. 23 shows a sample electrical block diagram of an electronic device 2300 that may perform the operations described herein. The electronic device 2300 may in some cases take the form of any of the electronic devices described with reference to FIGS. 1A-22, including client devices, and/or servers or other computing devices associated with the system 100. The electronic device 2300 can include one or more of a processing unit 2302, a memory 2304 or storage device, input devices 2306, a display 2308, output devices 2310, and a power source 2312. In some cases, various implementations of the electronic device 2300 may lack some or all of these components and/or include additional or alternative components.

The processing unit 2302 can control some or all of the operations of the electronic device 2300. The processing unit 2302 can communicate, either directly or indirectly, with some or all of the components of the electronic device 2300. For example, a system bus or other communication mechanism 2314 can provide communication between the processing unit 2302, the power source 2312, the memory 2304, the input device(s) 2306, and the output device(s) 2310.

The processing unit 2302 can be implemented as any electronic device capable of processing, receiving, or transmitting data or instructions. For example, the processing unit 2302 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 2300 can be controlled by multiple processing units. For example, select components of the electronic device 2300 (e.g., an input device 2306) may be controlled by a first processing unit and other components of the electronic device 2300 (e.g., the display 2308) may be controlled by a second processing unit, where the first and second processing units may or may not be in communication with each other.

The power source 2312 can be implemented with any device capable of providing energy to the electronic device 2300. For example, the power source 2312 may be one or more batteries or rechargeable batteries. Additionally, or alternatively, the power source 2312 can be a power connector or power cord that connects the electronic device 2300 to another power source, such as a wall outlet.

The memory 2304 can store electronic data that can be used by the electronic device 2300. For example, the memory 2304 can store electronic data or content such as, for example, audio and video files, documents and applications, device settings and user preferences, timing signals, control signals, and data structures or databases. The memory 2304 can be configured as any type of memory. By way of example only, the memory 2304 can be implemented as random access memory, read-only memory, flash memory, removable memory, other types of storage elements, or combinations of such devices.

In various embodiments, the display 2308 provides a graphical output, for example associated with an operating system, user interface, and/or applications of the electronic device 2300 (e.g., a chat user interface, an issue-tracking user interface, an issue-discovery user interface, etc.). In one embodiment, the display 2308 includes one or more sensors and is configured as a touch-sensitive (e.g., single-touch, multi-touch) and/or force-sensitive display to receive inputs from a user. For example, the display 2308 may be integrated with a touch sensor (e.g., a capacitive touch sensor) and/or a force sensor to provide a touch- and/or force-sensitive display. The display 2308 is operably coupled to the processing unit 2302 of the electronic device 2300.

The display 2308 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 2308 is positioned beneath and viewable through a cover that forms at least a portion of an enclosure of the electronic device 2300.

In various embodiments, the input devices 2306 may include any suitable components for detecting inputs. Examples of input devices 2306 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 2306 may be configured to detect one or more particular types of input and provide a signal (e.g., an input signal) corresponding to the detected input. The signal may be provided, for example, to the processing unit 2302.

As discussed above, in some cases, the input device(s) 2306 include a touch sensor (e.g., a capacitive touch sensor) integrated with the display 2308 to provide a touch-sensitive display. Similarly, in some cases, the input device(s) 2306 include a force sensor (e.g., a capacitive force sensor) integrated with the display 2308 to provide a force-sensitive display.

The output devices 2310 may include any suitable components for providing outputs. Examples of output devices 2310 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 2310 may be configured to receive one or more signals (e.g., an output signal provided by the processing unit 2302) and provide an output corresponding to the signal.

In some cases, input devices 2306 and output devices 2310 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 2302 may be operably coupled to the input devices 2306 and the output devices 2310. The processing unit 2302 may be adapted to exchange signals with the input devices 2306 and the output devices 2310. For example, the processing unit 2302 may receive an input signal from an input device 2306 that corresponds to an input detected by the input device 2306. The processing unit 2302 may interpret the received input signal to determine whether to provide and/or change one or more outputs in response to the input signal. The processing unit 2302 may then send an output signal to one or more of the output devices 2310, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for automation rule creation within a content collaboration platform, the method comprising:
authenticating a user with respect to an instance of a content collaboration platform;
causing generation of a graphical user interface of the content collaboration platform, the graphical user interface including an editor panel configured to receive user-generated content for an electronic document and a navigation panel displaying a hierarchical element tree having a set of elements selectable to cause display of a respective electronic document;
in response to a first user input to the graphical user interface, the first user input configured to initiate an action associated with an action type, determine whether a system use condition associated with the authenticated user satisfies a prompt criteria;
in accordance with the system use condition satisfying the prompt criteria, select an automation rule template corresponding to the action type, the automation rule template configured to generate an automation rule that automatically initiates future actions associated with the action type;
cause display of a rule suggestion interface, the rule suggestion interface having a set of graphical elements, each respective graphical element of the set of graphical elements corresponding to a respective automation component of the automation rule template;
in response to a second user input provided to the rule suggestion interface, assigning a value to an instance of an automation component associated with a graphical element of the set of graphical elements; and
in response to a third user input, cause creation of a new automation rule, the new automation rule having a set of automation components corresponding to the set of graphical elements of the rule suggestion interface, wherein the new automation rule includes the instance of the automation component having the assigned value.

2. The computer-implemented method of claim 1, wherein:
the automation component is a first automation component;
the new automation rule includes a second automation component defining a trigger criteria; and
the method further comprises, in response to detecting that an event occurring within the content collaboration platform satisfies the trigger criteria, executing the new automation rule.

3. The computer-implemented method of claim 2, wherein:
the action initiated by the first user input includes a content item operation with respect to a first content item; and
a third automation component of the new automation rule is configured to initiate the content item operation with respect to a second content item different from the first content item.

4. The computer-implemented method of claim 1, wherein the system use condition satisfies the prompt criteria if the user has not created an automation rule instance using the automation rule template within a time window.

5. The computer-implemented method of claim 1, wherein the second user input corresponds to a user selection of the value from a list of candidate values, the list of candidate values displayed in association with the graphical element of the automation component.

6. The computer-implemented method of claim 5, wherein the list of candidate values comprises a list of user identifiers, the list of user identifiers corresponding to users of the content collaboration platform.

7. The computer-implemented method of claim 5, further comprising:
in response to selecting the automation rule template and in accordance with a determination that a particular automation component of the automation rule template is associated with a third-party service, sending a request to the third-party service requesting the list of candidate values; and
receiving, from the third-party service, the list of candidate values for display in the rule suggestion interface.

8. A computer-implemented method for automation rule creation within a content collaboration platform, the method comprising:
causing generation of a graphical user interface of a content collaboration platform, the graphical user interface including an editor panel configured to receive user-generated content for an electronic document and a navigation panel displaying a hierarchical element tree having a set of elements selectable to cause display of a respective electronic document;
in response to a first user input to the graphical user interface, the first user input configured to initiate an action associated with an action type, select an automation rule template corresponding to the action type, the automation rule template configured to generate an automation rule that automatically initiates future actions associated with the action type;
cause display of a rule suggestion interface, the rule suggestion interface having a set of graphical elements, each respective graphical element of the set of graphical elements corresponding to a respective automation component of the automation rule template, wherein a particular graphical element of the set of graphical elements is associated with a particular automation component and is configured to receive a user-specified value; and
in response to a second user input requesting creation of a proposed new automation rule according to the automation rule template:
determine whether the proposed new automation rule satisfies a validation criteria with respect to the particular automation component;
in accordance with a determination that the proposed new automation rule fails to satisfy the validation criteria with respect to the particular automation component, provide a graphical error indication in the rule suggestion interface in association with the particular graphical element; and
in accordance with a determination that the proposed new automation rule satisfies the validation criteria with respect to the particular automation component, causing creation of the proposed new automation rule.

9. The computer-implemented method of claim 8, wherein the proposed new automation rule fails to satisfy the validation criteria with respect to the particular automation component if no user-specified value has been received.

10. The computer-implemented method of claim 8, wherein:
the particular graphical element includes a list of candidate values; and
the computer-implemented method further includes:
receiving a third user input corresponding to a user selection of a value from the list of candidate values; and
generating the proposed new automation rule, wherein the proposed new automation rule includes the user selected value.

11. The computer-implemented method of claim 10, further comprising:
in response to selecting the automation rule template, sending a request to a third-party service to request the list of candidate values; and
receiving, from the third-party service, the list of candidate values for display in the rule suggestion interface.

12. The computer-implemented method of claim 8, wherein the automation rule template includes:
a trigger automation component corresponding to triggering condition; and
an action automation component corresponding to the action type.

13. The computer-implemented method of claim 8, wherein:
the rule suggestion interface includes a text input field configured to receive a text input; and
the text input is associated with the proposed new automation rule.

14. The computer-implemented method of claim 13, wherein the text input is a title of the proposed new automation rule.

15. A computer-implemented method for automation rule creation within a content collaboration platform, the method comprising:
authenticating a user with respect to an instance of a content collaboration platform;
causing generation of a graphical user interface of the content collaboration platform, the graphical user interface including an editor panel configured to receive user-generated content for an electronic document and a navigation panel displaying a hierarchical element tree having a set of elements selectable to cause display of a respective electronic document;
in response to a first user input to the graphical user interface, the first user input configured to initiate an action associated with an action type:
determine whether a system use condition associated with the authenticated user satisfies a first prompt criteria; and
determine whether a permission level of the authenticated user satisfies a second prompt criteria;
in accordance with a determination that each prompt criteria of a set of prompt criteria is satisfied, the set of prompt criteria including the first prompt criteria and the second prompt criteria, select an automation rule template corresponding to the action type, the automation rule template configured to generate an automation rule that automatically initiates future actions associated with the action type;
cause display of a rule suggestion interface, the rule suggestion interface having a set of graphical elements, each respective graphical element of the set of graphical elements corresponding to a respective automation component of the automation rule template; and
in response to a second user input, cause creation of a new automation rule, the new automation rule having a set of automation components corresponding to the set of graphical elements of the rule suggestion interface.

16. The computer-implemented method of claim 15, wherein:
the content collaboration platform is a first software platform;
the action type is associated with a second software platform;
the computer-implemented method further comprises, in response to the first user input to the graphical user interface, communicating with the second software platform to determine whether an account status of authenticated user satisfies a third prompt criteria; and
the set of prompt criteria further includes the third prompt criteria.

17. The computer-implemented method of claim 16, wherein the authenticated user satisfies the third prompt criteria if the account status of the authenticated user is associated with a user account of the second software platform.

18. The computer-implemented method of claim 16, wherein:
the system use condition is a first system user condition;
the computer-implemented method further comprises, in response to the first user input to the graphical user interface, determining whether a second system use condition satisfies a fourth prompt criteria;
the second use condition satisfies the fourth prompt criteria if the authenticated user has not previously dismissed the rule suggestion interface within a time window.

19. The computer-implemented method of claim 16, further comprising, in response to a third user input provided to the rule suggestion interface, assigning a value to an instance of an automation component associated with a graphical element of the set of graphical elements, wherein the new automation rule includes the instance of the automation component having the assigned value.

20. The computer-implemented method of claim 19, wherein:
the computer-implemented method further includes:
in response to selecting the automation rule template, sending a request to the second software platform to request a list of candidate values; and
receiving, from the second software platform, the list of candidate values for display in the rule suggestion interface;
a graphical element of the set of graphical elements in the rule suggestion interface includes a list picker element including the list of candidate values; and
the third user input corresponds to a user selection of a value from the list of candidate values.
